(19) United States
(12) Patent Application Publication
(10) Pub. No.: US 2026/0299577 A1
(43) Pub. Date: Oct. 1, 2026

(54) SYSTEM AND METHOD OF ROBUST AND HIGHLY GENERALIZED FAULTY SENSOR DATA DETECTION FOR MONITORING APPLICATIONS

(71) Applicant: GM GLOBAL TECHNOLOGY OPERATIONS LLC, Detroit, MI (US)

(72) Inventors: Zijun Han, Madison Heights, MI (US); Jinzhu Chen, Troy, MI (US); Fan Bai, Ann Arbor, MI (US)

(73) Assignee: GM GLOBAL TECHNOLOGY OPERATIONS LLC, Detroit, MI (US)

(21) Appl. No.: 19/092,864

(22) Filed: Mar. 27, 2025

(51) Int. Cl. G05B 23/02

(52) U.S. Cl. CPC G05B 23/0281

(57) ABSTRACT

A method includes receiving sensor data from a group of sensors including real time location sensors used to perform localization of an object, and determining temporal dependencies of sensor data from the same sensor, repeated for multiple sensors, and spatial dependencies among sensor data from different sensors from the group of sensors. The method includes generating indicators that indicate whether sensor data associated with individual sensors of the group of sensors is faulty sensor data including inputting the spatial and temporal dependencies into a convolutional neural network (CNN), and restoring the faulty sensor data including combining a version of the indicators with a version of the sensor data associated with the indicators to generate combined fault data. The method includes inputting the combined fault data into a multi-attention transformer neural network, and performing the localization using restored non-faulty sensor data to find a location of the object.

### INTRODUCTION

The present disclosure relates to analysis of sensor data collected to monitor various conditions or parameters, and more particularly to faulty sensor data detection and restoration.

Many different objects, systems, environments, and situations are monitored using sensors that provide parameter data including for navigation, vehicle performance, health monitoring of living beings, traffic, weather, industrial machinery, residential, commercial, and industrial buildings, computing and mobile devices, and many others. Faulty sensor data can occur due to varying environmental conditions around the sensors that can interfere with the operations of the sensors, such as terrain that blocks wireless emissions from a sensor, and a sensor may have faulty data in many different environmental conditions or domains. Machine learning techniques may be used to detect faulty sensor data when it occurs. Accordingly, it is desirable to provide systems and methods that enable more robust faulty sensor data detection in a large variation of domains without the need for an excessively large training dataset. Furthermore, other desirable features and characteristics of the present disclosure will become apparent from the subsequent detailed description and the appended claims, taken in conjunction with the accompanying drawings and the foregoing introduction.

### BRIEF SUMMARY

In an example implementation, a method includes receiving, by at least one processor, sensor data from a group of sensors including real time location sensors used to perform localization of an object, and determining, by at least one processor, temporal dependencies of sensor data from the same sensor, repeated for multiple sensors, from the group of sensors, and spatial dependencies among sensor data from different sensors from the group of sensors. The method includes generating, by at least one processor, indicators that indicate whether sensor data associated with individual sensors of the group of sensors is faulty sensor data including inputting the spatial and temporal dependencies into a convolutional neural network (CNN), and restoring the faulty sensor data to non-faulty sensor data and including combining a version of the indicators with a version of the sensor data associated with the indicators to generate combined fault data. The method includes inputting the combined fault data into a multi-attention transformer neural network, and performing the localization using the non-faulty sensor data to find a location of the object.

In another example implementation, the non-faulty sensor data is distance readings, and the localization includes using locations of the real time location sensors and the distance readings to perform trilateration by applying a least squares function or a density-based spatial clustering of applications with noise (DBSCAN) function.

In another example implementation, the method includes the spatial dependencies into a spatial diagonal matrix with spatial dependency values in the spatial diagonal matrix to show a dependency among each available pair of sensors of the group of sensors, and inputting the spatial diagonal matrix into the CNN.

In another example implementation, the method includes formatting the temporal dependencies into a temporal diagonal matrix with temporal dependency values in the temporal diagonal matrix to show a dependency among each available pair of different sample time points for a single sensor of the group of sensors, and repeated for multiple sensors, and inputting the temporal diagonal matrix into the CNN.

In another example implementation, the CNN includes a sequence of multiple CNN blocks that are repeated neural network blocks having the same neural network structure to define a number of iterations and output intermediate features at each CNN block, Output of each block are intermediate features and are each a three dimensional vector including a first channel of a number of samples over time obtained for the group of sensors, a second channel of a number of sensors in the group of sensors, and a third channel being a feature channel with the indicators in a form of multiple feature values that cooperatively from a feature map and that indicate a feature distribution. The CNN is trained so that different output feature distributions from the CNN indicate faulty data of different sensors.

In another example implementation, the method includes training the CNN including inputting the indicators output from the CNN into both a faulty sensor data classifier neural network and a domain-adaptive neural network (DA-NN). The faulty sensor data classifier neural network only operates with labeled training data and the DA-NN operates with both labeled and unlabeled training data.

In another example implementation, the training includes the DA-NN generating a dynamic weighting factor for a domain adaptive loss used to modify weights of the CNN, and the dynamic weighting factor depends on a distribution difference quantity that is a difference between a source and target domain.

In another example implementation, the distribution difference quantity is determined by using Maximum Mean Discrepancy (MMD).

In an example implementation, the distribution difference quantity is determined by using radial basis function (RBF) kernels.

In another example implementation, the method includes using both a ground truth loss from the faulty sensor data classifier neural network and a domain adaptive loss from the DA-NN to modify weights of the CNN.

In another example implementation, a system includes memory, processor circuitry forming at least one processor communicatively coupled to the memory and being arranged to operate by: receiving sensor data from a group of sensors including real time location sensors used to perform localization of an object, determining temporal dependencies of sensor data from the same sensor, repeated for multiple sensors, from the group of sensors, and spatial dependencies among sensor data from different sensors from the group of sensors, and generating indicators that indicate whether sensor data associated with individual sensors of the group of sensors is faulty sensor data including inputting the spatial and temporal dependencies into a convolutional neural network (CNN). The at least one processor also being arranged to operate by restoring the faulty sensor data to non-faulty sensor data and including combining a version of the indicators with a version of the sensor data associated with the indicators to generate combined fault data, and inputting the combined fault data into a multi-attention transformer neural network, performing a monitoring task including using the non-faulty sensor data, and pre-training the CNN including providing the indicators to both a faulty sensor data classifier neural network and a domain adaptive neural network (DA-NN) arranged to increase generalization of the CNN to cross-domains with the same group of sensors but with different environments from domain to domain affecting the same group of sensors.

In another example implementation, the monitoring task is related to health monitoring with multiple different types of sensors in the group of sensors including at least for heart monitoring and human body motion to cooperatively generate a health score.

In another example implementation, the monitoring task is related to at least one of: navigation, vehicle performance and maintenance, health monitoring of living beings, traffic, weather, industrial machinery, residential, commercial, and industrial buildings, utility systems, and appliances, computers, computing devices, and mobile devices, industrial machinery, environmental conditions, security, occupancy, noise levels, light intensity, water usage, gas detection, smoke detection, vibrations, structural integrity, waste management, alert systems, asset tracking, worker safety, resource allocation, manufacturing processes, energy efficiency, cooling systems, machine status, and device authentication.

In another example implementation, at least one sensor of the group of sensors has multiple dependencies including both temporal and spatial dependencies.

In another example implementation, the CNN includes multiple blocks that is a repeated neural network block used for multiple iterations. Each block has, in order: a spatial feature embedding layer that embeds the spatial dependencies with either (1) output intermediate features from a prior block, or (2) sensor data values used to form the spatial dependencies, and to form a spatial enriched features, a first subtractor to compute first differences between (1) either the output intermediate features from a previous block or the sensor data and (2) values of the spatial enriched features, a first one or more convolutional layers using the first differences, a first Rectified Linear Unit (ReLU) layer using results from the first one or more convolutional layers and to form first ReLU results, a temporal feature embedding layer that receives the temporal dependencies and embeds the temporal dependencies with the first ReLU results to generate temporal enriched features, a second subtractor that computes second differences between the first ReLU results and the temporal enriched features, a second one or more convolutional layers using the temporal enriched features, and a second ReLU layer that uses the results of the second one or more convolutional layer(s) and outputs next intermediate features.

In another example implementation, at least one non-transitory computer-readable medium including instructions thereon that when executed by a computing device, cause the computing device to operate by:

In another example implementation, the instructions cause the computing device to operate by generating a normalization Â of an adjacency matrix Ã by: Â=\tilde{D}^{-1/2}Ã \tilde{D}^{-1/2}, where D is a diagonal degree matrix of connecting weight sums of individual dependency values, and Ã is a matrix of the spatial or temporal dependency values. The connecting weight sums are each a sum of the spatial or temporal dependency values having an edge connected to an individual sensor value.

In another example implementation, the instructions cause the computing device to operate by multiplying the normalized adjacency matrix by feature channel data from a prior CNN block.

In another example implementation, the instructions cause the computing device to operate by converting a version of the indicators and a version of the sensor data into separate embeddings expected for positional encoding, and performing multi-variant word embedding to combine the separate embeddings into a combined vector to be input to the multi-attention transformer neural network.

In another example implementation, the multi-attention transformer neural network includes a spatial encoder that receives the combined vector and a temporal encoder that receives a concatenation of output from the spatial encoder and the combined vector.

### BRIEF DESCRIPTION OF THE DRAWINGS

The present disclosure will hereinafter be described in conjunction with the following figures. The figures are not to scale and numerals in the figures denote like elements, and where:

FIG. 1 is a schematic diagram of an example device with a system to detect faulty sensor data according to at least one of the implementations herein;

FIG. 2 is a schematic diagram of an example monitoring data analysis system according to at least one of the implementations herein;

FIG. 3 is a schematic diagram of an example sensor situation that uses sensors to monitor an object according to at least one of the implementations herein;

FIG. 4 is a schematic diagram of an example domain-adaptive spatial-temporal graph convolutional neural network (DA-ST-GCN) unit of the system of FIG. 2 according to at least one of the implementations herein;

FIG. 5 is a schematic diagram of an example sensor data input sequence array according to at least one of the implementations herein;

FIG. 6 is a chart showing example temporal dependency correlations of sensor data from a sensor according to at least one of the implementations herein;

FIG. 7 is a chart showing example spatial dependency correlations between sensor data from multiple sensors according to at least one of the implementations herein;

FIG. 8 is a schematic diagram of an example conceptual spatial adjacency sensor arrangement according to at least one of the implementations herein;

FIG. 9 is a schematic diagram of an example conceptual temporal adjacency sensor arrangement according to at least one of the implementations herein;

FIG. 10 is a schematic diagram of an example conceptual sensor arrangement showing both spatial and temporal adjacency according to at least one of the implementations herein;

FIG. 11 is a schematic diagram of an example graph showing temporal and spatial dependency among sensors and sensor readings according to at least one of the implementations herein;

FIG. 12 is a schematic diagram of an example dependency input matrix according to at least one of the implementations herein;

FIG. 13 is a schematic diagram of an example graph convolution neural network (GCN) block according to at least one of the implementations herein;

FIG. 14 is a schematic diagram of a training arrangement with an example faulty sensor identification neural network and an example domain classifier neural network according to at least one of the implementations herein;

FIGS. 15A-15G are charts showing domain distributions to classify domains according to at least one of the implementations herein;

FIGS. 16A-16B is a schematic diagram of an example sensor data restoration system according to at least one of the implementations herein;

FIG. 17 is a schematic diagram of an example flow chart of detecting faulty sensor data and denoising faulty sensor data to restore sensor values according to at least one of the implementations herein; and

FIG. 18 is a schematic diagram of an example flow chart of training the faulty sensor data detection neural networks according to at least one of the implementations herein.

### DETAILED DESCRIPTION

The following detailed description merely presents example implementations and is not intended to limit the disclosure or the application and uses thereof. Furthermore, no intention exists to be bound by any theory presented in the preceding background or the following detailed description.

Faulty sensor data may result from external sources such as an environment around a sensor that blocks or reflects wireless communication or monitoring emissions or signals emitted from the sensor, and may be referred to as temporary causes of the fault. Otherwise, a permanent cause of the fault is one where either a sensor is internally damaged or the senor was unintentionally moved from a fixed, expected, mounted position on an object (such as a vehicle) to an unexpected position of the sensor on the object, and where the sensor is still operating and providing sensor data. The faults may show as missing measurements, random missing values including short-term reading errors, missing values of temporal blocks (or long-term blockages), non-line of sight (NLOS) measurement issues such as random jumps or constant second path interference, and so forth.

For any of these types of faults, a method and system of analysis of monitoring data disclosed herein includes detecting faulty sensor data and optionally denoising (or restoring or cleaning the sensor data) for a group of sensors with a common goal. Such a common goal may be many different objectives and is not particularly limited. Some common goals may be a final score, such as a health score for a person, or location of an object for a localization sensor group. The disclosed methods and systems use a data-oriented machine-learning approach that enhances robustness by effectively identifying inaccurate measurements and denoising or restoring the inaccurate measurements to be more accurate. This is accomplished by analyzing the spatial and temporal correlations (or dependencies) among sensor data from the group of sensors.

More specifically, spatial and temporal dependencies among the sensor data is determined to form a dependency graph that is input into a domain-adaptive spatial-temporal Graph Convolutional Neural Network (DA-ST-GCN), model, or unit (or just GCN unit). The GCN unit has a graph convolution neural network (GCN) in a form of a sequence of repeating GCN blocks that performs faulty sensor data (or abnormality) detection on the input sensor data of the dependency graph. This identifies the faulty sensor data, and in turn a source sensor of the faulty sensor data from the group of the sensors being used. Then, a multi-attention transformer neural network may be used to generate restored or clean sensor values by using both separately embedded abnormality detection data and embedded sensor data that are combined and input to multi-attention transformer. The transformer may have a spatial encoder and a temporal encoder to handle the spatial and temporal dependencies.

To train the GCN, two training neural networks are used: one neural network uses labeled training datasets for supervised learning, while the other neural network uses both labeled and unlabeled training data to perform semi-supervised learning. The supervised neural network is a ground truth or faulty sensor identification neural network (FS-ID NN) of the monitoring data analysis system or model, and provides a ground truth loss to modify weights of the GCN during the training. The semi-supervised neural network is a domain-adaptive neural network (DA-NN) that provides a domain-adaptive loss adjusted by using a dynamic domain adaptive parameter and then to modify the weights of the GCN. The DA-NN generalizes the GCN to handle a variety of domains applicable to a group of sensors as described herein.

Particularly, the disclosed system with the GCN can be used in a wide variety of monitoring situations or domains for the same group of sensors. For a group of localization sensors on a vehicle for example, the domains may be inside, outside, in a garage, in bad weather, different terrains such as mountains, or forests, etc. The generalization to various domains can be achieved because it has been found that the coordinative sensor data (that can have mapped locations or other mapping structure or concepts) has hidden domain-independent correlations. Thus, the DA-NN can be used to provide good cross-domain performance where cross-domain refers to a change in environment around the group of sensors (or change in “application space”), or change in sensor reading distribution. The DA-NN improves generalization while using both the labeled and unlabeled training data to reduce the requirement to have a fully labeled dataset. It also has been found that the DA-NN trained GCN is effective for various applications (not to be confused with various domains for a single group of sensors described herein), where various applications refers to any different common goal of the sensors such as monitoring for localization or object detection, monitoring of environments such as a certain geography (as for security), weather, traffic or vehicle travel, computer, computing devices, smartphones and devices, software system monitoring, industrial machine monitoring, building monitoring such as residential, commercial, or industrial, and so forth without any particular limit. No particular limit exists as to the type of sensor group or application as long as all of the sensors in the group of sensors contribute to, and affect, the common goal directly or indirectly.

Thus, the implementations of the disclosed methods and systems better ensure robust performance across diverse environments, while in turn, improving the robustness of end applications regardless of different environmental conditions and with relatively limited training data.

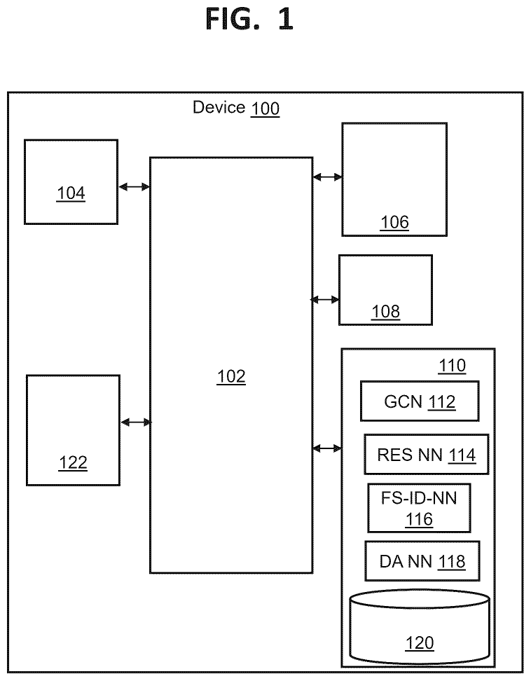

Referring now to FIG. 1, an example device or system 100 has a monitoring data analysis system 106, and the devise or system 100 may be the device being monitored, or may simply be the device that has monitoring data analysis system 106 described herein. The object, environment, or situation being monitored may or may not be remote from the device 100. In one implementation, device 100 is a vehicle such as an automobile, but may be any vehicle whether aircraft, watercraft, spacecraft, and so forth as long as it uses sensors to collect sensor data to monitor a condition of the vehicle and its parts and systems 122, such as the steering system, drive system engine, and so forth, or to monitor an environment external to the vehicle such as for navigation or localization of remote objects.

The device 100 has processor circuitry that forms one or more processors 102 to receive data from sensors 104 and to operate the monitoring data analysis system 106, which also may be referred to herein as a faulty sensor data detection system. The device 100 also may have other applications 108, such as navigation or autonomous driving applications that uses the sensor data. These applications 108 may be referred to as end applications, but include any application that can use the sensor data from sensors 104.

The device 100 also has memory 110 that may hold any of the operating systems or applications mentioned herein, and also may hold data to operate neural networks or other machine learning algorithms used by the monitoring data analysis system 106, and this may include a graph convolutional neural network (GCN) 112, a restoration neural network (RES NN) 114, a faulty sensor identification neural network (FS_ID_NN) 116, and/or a domain-adaptive neural network (DA-NN) 118, as well as a NN database 120 that holds any network-related data, such as sensor data in any version including raw input data, intermediate feature data, and/or output data, layer weights, biases, training gradients, loss values, activation functions and computation values, and so forth, and that is being used by any of the neural networks herein. The hardware of the neural networks, as mentioned below, may be considered part of the processors 102.

By one example, the sensors 104 may include a sensor array or other sensor arrangement, and may include one or more of the cameras of any desired type, one or more other detection sensors (e.g., radar, sonar, light detection and ranging (LiDAR), infrared, real-time location sensors (RTLSs), signal measuring sensors such as Wi-Fi or Bluetooth strength sensors, or the like) and/or other sensors (e.g., vehicle position sensors, speed sensors, accelerometers, gyroscopes, inertial sensors, braking sensors, steering sensors, inertial measurement units (IMUs), and so on).

Other devices may have different types of sensors that are considered to be included here whether the sensors are located on the same device or are remote from each other. Thus, sensors 104 may include any sensors used for any monitoring arrangement such as to monitor vehicle performance and maintenance, navigation, health, traffic, weather, industrial machinery, robotics, residential buildings, commercial buildings, industrial buildings, automation systems, appliances, computers, computing devices, mobile devices, environmental conditions, air quality, temperature, humidity, pressure, motion, energy usage, security, occupancy, noise levels, light intensity, water usage, gas detection, smoke detection, vibrations, structural integrity, fault detection, performance optimization, waste management, asset tracking, worker safety, disease monitoring, biometric data, sleep patterns, heart rate, blood pressure, glucose levels, ECG, brain activity, proximity detection, resource allocation, manufacturing processes, energy efficiency, cooling, heating, and ventilating systems, machine status, device authentication, and many others. This also may include software sensors that monitor other software systems, such as software sensors that monitor the autonomous driving system on a vehicle may be considered a group of sensors as defined herein as well. Many variations can be included.

As to the type of sensors within the group of sensors with a common goal as discussed herein, the group of sensors may be a group of the same type of sensor or different types of sensors as long as the sensors are contributing sensor data to that common goal and that same group of sensors is maintained for operation of the monitoring data analysis unit 106. The common goal can be determining a monitoring score, such as a health score for a person when various objects and things are being monitored, such as a heartbeat, blood content, motion of the person, and so forth. Otherwise, detecting a location of an object or determining a self-location may be the common goal for sensors all of the same type, such as a group that only has RTLSs.

Now in more detail, it will be appreciated that the processor(s) 102 may be or have a control system and/or controller to operate the other units and systems of device 100. It also will be appreciated that the device 100 may differ from the implementation depicted in FIG. 1. For example, the processor(s) 102 may be coupled to, or may otherwise utilize, one or more remote computer systems and/or other remote control systems, for example as part of one or more of the above-identified units or systems of system 100.

In various implementations, the processor(s) 102 are part of, or is, a computer system, and includes the memory 110 and a computer bus (not shown). In various implementations, the processor(s) 102 obtain sensor data from the sensors 104, and in certain implementations additional data through one or more communications systems, such as transceivers, when the sensors 104 or any other unit or system (or any part of a unit or system) is physically remote from the device 100 and processor(s) 102.

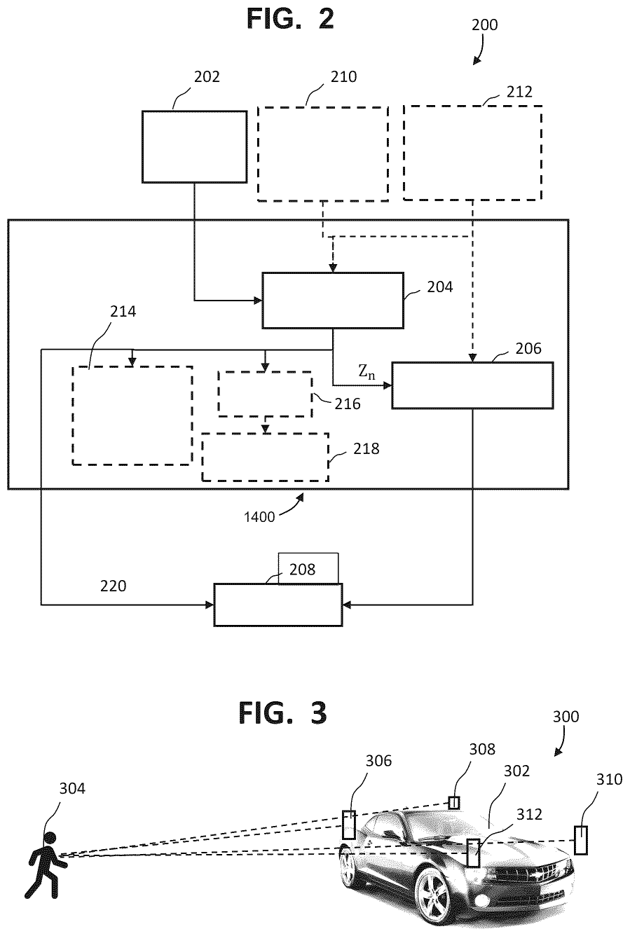

In the depicted implementation, the processor(s) 102 may comprise circuitry or circuits to operate any of the units or systems shown on device 100 including circuitry to operate the neural networks. The processor(s) 102 form any type of processor or multiple processors, single integrated circuits such as a microprocessor, or any suitable number of integrated circuit devices and/or circuit boards working in cooperation to accomplish the functions of a processing unit. This may include a System on a chip (SoC) and one or more processor cores, and/or shared hardware circuits such as with a central processing unit (CPU), digital signal processor (DSP), and so forth. Otherwise, dedicated or specific function processors may be provided that operate neural networks, including convolutional neural networks, linear layers, and so forth, and other structures for sensor data analysis for example, such as with Application-Specific Integrated Circuits (ASICs), Field-Programmable Gate Arrays (FPGAs), Neural Processing Units (NPUs), graphical processing units (GPUs), image signal processors (ISPs), and so forth. During operation, the processor 102 executes one or more programs or applications 106 or 108 that may be stored within the memory 110 and, as such, controls the general operations of a controller or computer system of the controller, when provided for the vehicle, and generally in executing the processes described herein, such as the processes and implementations depicted in FIGS. 2-18 and as described further below in connection therewith.

The memory 110 can be any type of suitable memory and may include one physical memory or multiple memories either at a same device or remote from each other, or any combination thereof. For example, the memory 110 may include various types of dynamic random access memory (DRAM) such as SDRAM, the various types of static RAM (SRAM), cache, and the various types of non-volatile memory (PROM, EPROM, and flash drive). In certain examples, the memory 110 is located on and/or co-located on the same computer chip as the processor 102. In the depicted implementation, the memory 110 stores the above-referenced applications 106 and 108 along with one or more databases 120 (e.g., pertaining to neural network data and/or any other data related to the device 100 as described herein) and other stored values.

The bus mentioned above also may be provided on device 100 to transmit programs, data, status and other information or signals between the various components of the systems operated by processor(s) 102. The bus may be any suitable physical or logical means of connecting the processor(s) 102 and other computer systems and components. This includes, but is not limited to, direct hard-wired connections, fiber optics, infrared and wireless bus technologies. During operation, the monitoring data analysis system 106 or other applications 108 may be stored in the memory 110 and executed by the processor(s) 102.

It will be appreciated that while this example implementation is described in the context of a fully functioning computer system, those skilled in the art will recognize that the mechanisms of the present disclosure are capable of being distributed as an application with one or more types of non-transitory computer-readable signal bearing media as part of memory 110 and used to store the application and the instructions thereof and carry out the distribution thereof, such as a non-transitory computer readable medium bearing the application and containing computer instructions stored therein for causing a computer processor (such as the processor 102) to perform and execute the application, and particularly, the monitoring data analysis system 106 and the neural networks 112, 114, 116, and 118. Such an application may take a variety of forms, and the present disclosure applies equally regardless of the particular type of computer-readable signal bearing media used to conduct the distribution. Examples of signal bearing media include recordable media such as floppy disks, hard drives, memory cards and optical disks, and transmission media such as digital and analog communication links. It will be appreciated that cloud-based storage and/or other techniques may also be used in certain implementations. It will similarly be appreciated that the processor(s) 102 may form computer systems or controllers that may differ from the implementation depicted in FIG. 1, for example in that the processor(s) 102 may be coupled to or may otherwise utilize one or more remote computer systems and/or other control systems.

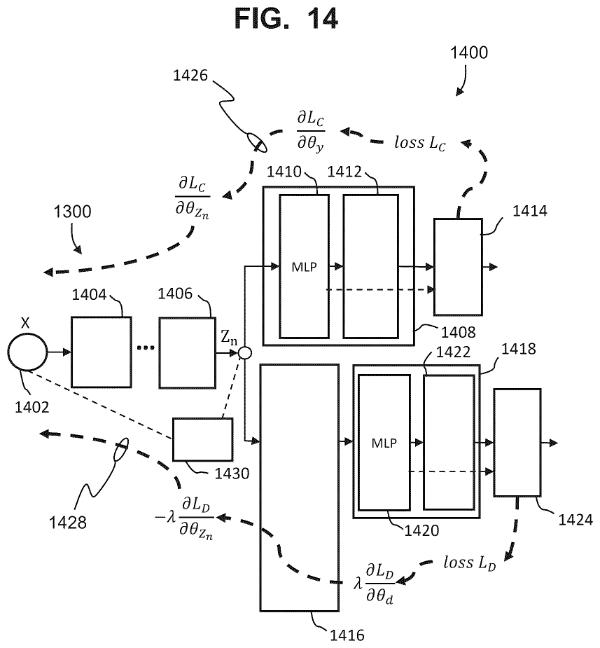

Referring to FIG. 2, an example implementation of a monitoring data analysis system (MDAS) 200 (which is a faulty sensor data detection system) is the same as system 106 (FIG. 1). The MDAS 200 has a sensor/monitoring data unit 202, a DA-ST-GCN backbone unit (or just GCN unit) 204, an optional restoration (or denoising) unit 206, and an applications unit 208 (which may or may not be considered part of the MDAS 200). The MDAS 200 also has units and input for training the neural network of the GCN unit 204. This includes inputs from training unlabeled cross-domain data input unit 210 and labeled source-domain data input unit 212. The training units that operate training neural networks to be used include a training faulty sensor identification unit 214, a gradient reversal unit 216, and a domain classifier unit 218 (all shown in dashed line) and that cooperatively form a training system 1400 (described in detail below with FIG. 14).

In operation, the sensor and/or monitoring data is received by the GCN unit 204 that has a convolutional neural network (CNN), also referred to as the GCN 112 (FIG. 1), and is described below. The GCN unit 204 generates intermediate features in the form of a feature distribution or feature map that represent correlations among sensor data and that identifies faulty sensor data. Thus, different feature distributions will indicate whether sensor data is faulty and which sensor is the source of the faulty sensor data. The source sensor may be referred to herein as a faulty sensor even though the sensor itself is not damaged. This refers to the case where the environment around the sensor has caused the fault, such as with walls reflecting a communications signal or trees blocking the communications signal, and where the fault may be temporary.

The sensor data as well as the intermediate features (also referred to as abnormality features) optionally may be provided to the restoration unit 206 to denoise or replace the faulty sensor data. The restored or clean data is then provided to end applications 208. Sensor reliability estimations 220 from the GCN unit 204 also may be provided to the applications 208. With this arrangement, the MDAS 200 performs data-oriented faulty sensor isolation and optionally data restoration.

In order to train the GCN and a faulty sensor identification neural network (FS-ID-NN) 116 of the faulty sensor identification unit 214, both labeled and unlabeled training data are provided from the training labeled source-domain data unit 212 and the training unlabeled cross-domain data unit 210, respectively, and from neural network training datasets. The FS-ID-NN 116 is operated by the faulty sensor identification unit 206 and is trained only on the labeled data to establish supervised learning. The faulty sensor identification unit 206 determines a ground truth loss form the outputs of the FS-ID-NN 116. Both the unlabeled and labeled training data are provided to the GCN unit 204 to train the GCN 112, which subsequently is considered to provide intermediate features to the gradient reversal unit 216 (as a place keeper) and then a domain classifier unit 220 which operates the DA-NN 118. The domain classifier 220 determines a domain loss (or adaptive-domain loss). Both the domain loss and the ground truth loss are used to generate gradients that in turn modify weights of the GCN 112 at the GCN unit 204. Thus, it can be stated that a first stage of the faulty sensor data detection process operates the GCN 112 that is pre-trained on both labeled and unlabeled data for accurate malfunctioning sensor detection, while in a second optional stage, the system 200 may perform signal restoration based on both the sensor readings and the backbone features extracted from the first stage. More details of the operation of the MDAS 200 are described below.

Referring to FIG. 3, a sensor arrangement 300 shows a vehicle 302 with four real time location sensors (RTLSs) 306, 308, 310, and 312 monitoring an object 304 such as a person by locating a key FOB or smartphone carried by the person. Such RTLSs may be ultra-wideband sensors. The processor(s) 102 that receive the sensor data from the sensors 306, 308, 310, and 312 may be at a controller on the vehicle or at another remote location in communication with the sensors or the computer systems or controller on the vehicle 302.

With the arrangement 300, the method and MDAS 200 of faulty sensor detection disclosed herein may be onboard the vehicle 302, and the system 200 will provide model robustness in terms of accurate sensor reading measurements. The disclosed system restores (or denoises or replaces or cleans) sensor readings previously distorted according to different conditions or environments such as for time of flight (TOF) for RTLS sensors 306, 308, 310, and 312 transmitting in ultrawideband (UWB) with line of sight (LOS) signals and a ranging accuracy being affected by multi-path signal reflections that bounce or reflect off of objects. The presently disclosed data-orientated approach enhances the localization accuracy by identifying faulty sensor data and the source sensor, and restores the inaccurate measurements to non-faulty sensor data.

The presently disclosed method and system also is trained to provide accurate results even when the vehicle 302 is moved to many different environments. Thus, the present method and system uses a training method that permits the use of a reduced training database (or data set or just training data) that generalizes the neural networks of the disclosed method and system to be adaptable for many different conditions and environments (or domains as described herein). The method and system may be trained for specific applications (such as the localization mentioned here) with the same set or group of sensors but for a variety of domains such as outdoors, inside of a garage, city or urban environment, and rural environment, to name a few more examples in addition to those mentioned above. This permits training of the neural networks with significantly smaller training datasets. This can be applied for many different sensors, including different localization sensors such as proximity sensors, auto security sensors, indoor navigation sensors, object tracking sensors, and device-to-device communication sensors, and so forth.

For example, say for this vehicle-based localization example arrangement 300, the example RTLS sensors 306, 308, 310, and 312 are non-line of sight (NLOS), Received Signal Strength Indicators (RSSIs) that provide signal strength measurements by using Wi-Fi or Bluetooth sensors, or time of flight (TOF) and angle or arrival (AOA) measurements that provide tag-anchor two-way-ranging data by using UWB sensors. When large objects block or interfere the communications, such as by trees or mountains, shadowing (signal power fluctuation) and other effects may occur resulting in a distorted signal and degraded signals with a significant loss. Thus, such sensors have difficulty with multi-path issues at certain sensor locations.

The sensor data from the sensors 306, 308, 310, and 312 are input into the DA-ST-GCN backbone unit 204, and specifically the GCN 112 to perform feature extraction. Thereafter, multi-attention signal restoration may be performed with the intermediate features as well. The result may be identification of the source sensor of the faulty sensor data as well as denoised sensor data, here being the TOA and the AOA.

The end (or downstream) applications 208 may perform the localization through trilateration in this example by apply least squares (LS), nonlinear least squares (NLLS), or density-based spatial clustering of applications with noise (DBSCAN) functions to localize the target based on sensors placement coordinates and distance readings. Many other variations and examples may be used instead.

By yet another example, a group of sensors may be provided for a common goal of a health score (or fitness data fusion) for a person. This may include various sensors on a mobile (phone) or wearable devices (watch or fit-band or skin-adhering devices), clinical data, and so forth that may provide sensor data such as acceleration or steps (i.e., the person's movement by acceleration signal peak detection), and heart rate from photoplethysmography (PPG), electrocardiogram readings (ECG), and so forth. A fault may occur due to device placement, poor skin contact, temperature variance, etc. The present system 200 and method may have the GCN unit 204 (and GCN 112) receive the input data and generate the intermediate and final features including identification of faulty sensor data (and faulty sensor(s)), and the restoration unit 206 then may use the intermediate or final features form the GCN 112 to generate cleaned sensor data. A health monitoring application can then generate a more correct fitness score estimation, which then can be used by other fitness and health applications.

Another example may include a smart city traffic monitor that generates GPS data, radar data, traffic flow data, traffic speed data and that is sensitive to obstructions by weather conditions and building interference. The present method and system improves the smart city operation as well. Many other examples for many other applications may be improved by the present method and system.

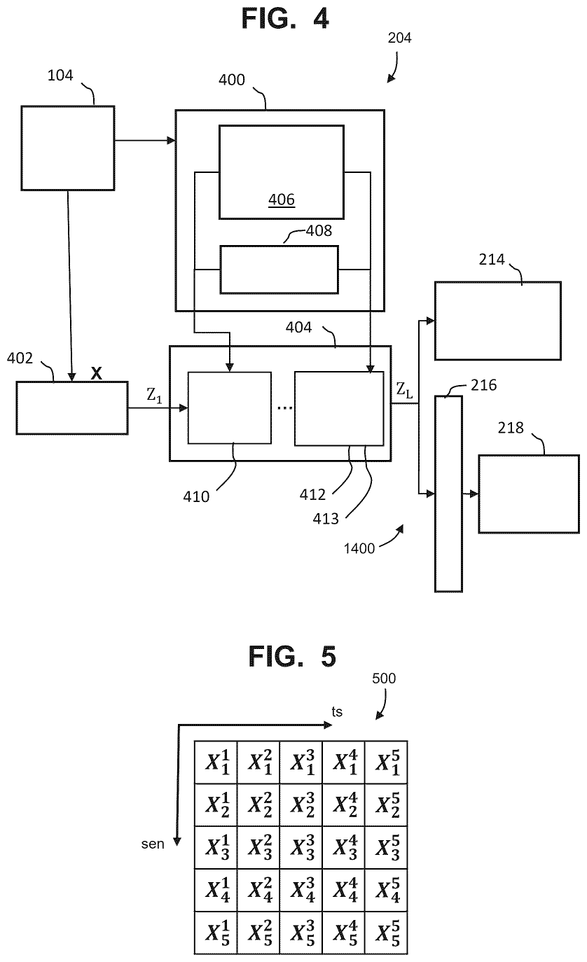

Referring to FIG. 4, the DA-ST-GCN backbone unit 204, has a dependency unit 400 with a spatial dependency unit 406 and a temporal dependency unit 408 that computes the dependencies and provides them to the GCN 404, which is the same as GCN 112, and is shown here with first spatial-temporal (ST) GCN block 1 (410) of multiple GCN blocks 412 to last GCN block N 413. The GCN bocks 1 to N (412) also may be referred to as CNN blocks since the GCN 404 uses convolutional layers. The number of GCN blocks 412 may depend on a desired speed of convergence during the training of the GCN 404 and/or other factors, and by one example uses at least two GCN blocks 412, and here two to four GCN blocks 412. It has been found that the first GCN block focuses more on the closer or adjacent interdependencies, while the later the GCN block in the sequence of GCN blocks 412, the focus is on pairs of sensors with a greater spatial or temporal distance between the two sensors.

The sensors 104 may provide raw sensor data (or formatted sensor data) to the dependency unit 400 to generate the dependencies. The senor data also is formatted by a sequential data unit 402 to place the sensor data first into sequential data arrays, and then re-formats the sensor data into an input vector structure expected by the first GCN block 1 (410).

Referring to FIG. 5 specifically, one example format for a sequential data array or table 500 has each sensor reading or sensor data value

$${X}_{t}^{i}$$

placed in rows that each represent a different sensor i of the group of sensors for a total of I sensors in the group of sensors being analyzed, and columns that each represent a different time point or sample time t within a total sampling duration T for collecting the sensor data. The duration and sample times (or intervals) may vary widely depending on the type of sensors being used and the use of the sensor data. The sequential data array is used for the sequential data unit 402 to store the incoming sensor data and organize the senor data for the re-formatting.

The sequential data then may be reformatted by the sequential data unit 402 or another unit. The reformatting here involves placing the sensor data values into in a matrix or vector form expected by the first GCN block 1 (410). Thus, the sequential data is reformatted to, or converted into, a three dimensional vector (m×I×X) for each sensor value or reading, where the first dimension m is the number of time intervals or samples t in the duration T, the second dimension I is the total number of sensors in the sensor group, and the third dimension X is the sensor value or values. Thus, say for example, localization is being performed where each sensor provides a magnitude as a time of arrival (TOA) or d, and a direction as an angle of arrival (AOA) or θ. In this case, the conversion can be seen as:

$${X}_{t}^{i} = [ {d}_{t}^{i} , {θ}_{t}^{i} ] \qquad ( 1 )$$

In the present example, say there are five time intervals, and four sensors in the group of sensors being analyzed. The three dimensional vector would be (5×4×2) where the five and four are simply counts of intervals and sensors, respectively, and where two features (TOA and AOA) are provided in a feature channel in the third dimension as a vector. Thus, for the initial sensor data input the feature channel may have as many features as provided by a single sensor for a single output time, and each three dimensional vector is provided for a single sensor. The input may be provided as separate channels or neural network surfaces, or may be a single channel of concatenated vectors whether organized into a single vector or a 2D surface, and so forth. Many variations may be used.

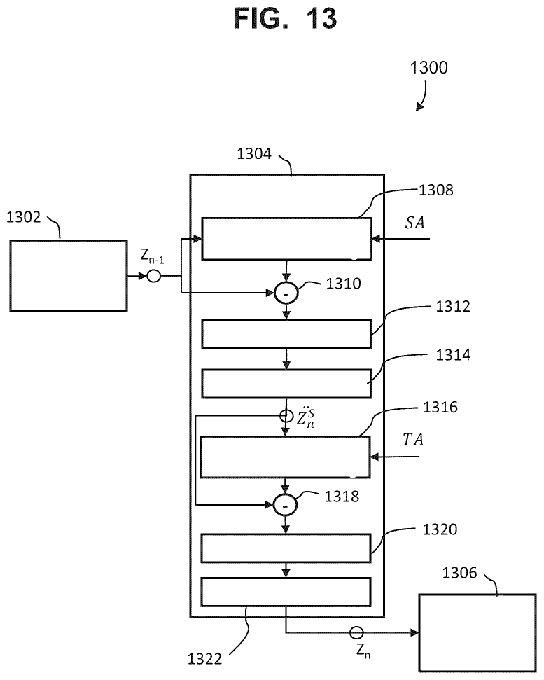

The operation of the GCN blocks 412 is explained below with FIG. 13. The output Zₙ of each of the GCN blocks 412 Z₁ or Z_{N} also is a three dimensional vector with a first element of a number m of time samples t in the duration T, a second element of a total number of sensors I of the group of sensors being analyzed together, and a third element that is a feature channel with a number of feature values (or just features) and that form a feature distribution or feature map. Thus, the operation of the GCN 404 may be referred to as feature extraction and the feature map or distribution output from each GCN block 412 may be referred to as an intermediate feature that is output at the individual GCN blocks 412. The features from the last GCN block N (412) also may be designated Z_{L}, but otherwise may be referred to as either an intermediate feature as well since it is output from a GCN block or final feature (or last feature) as output from the last GCN block N 413.

During a run-time, the last intermediate feature Z_{L} may be provided to a restoration or denoising system or unit 206 when desired to compute clean or restored sensor data values to replace the faulty sensor data. Otherwise during training, the last intermediate feature Z_{L} may be provided to both the FS-ID-NN 214 and the DA-NN 218 training neural networks (via the gradient reversal place-holder layer 216) as mentioned above. The FS-ID-NN 214 is used to generate ground truth loss while the DA-NN is used to generate adaptive domain loss for each epoch being run, and both losses are then used to modify the weights of the GCN. The training is explained below with FIG. 14.

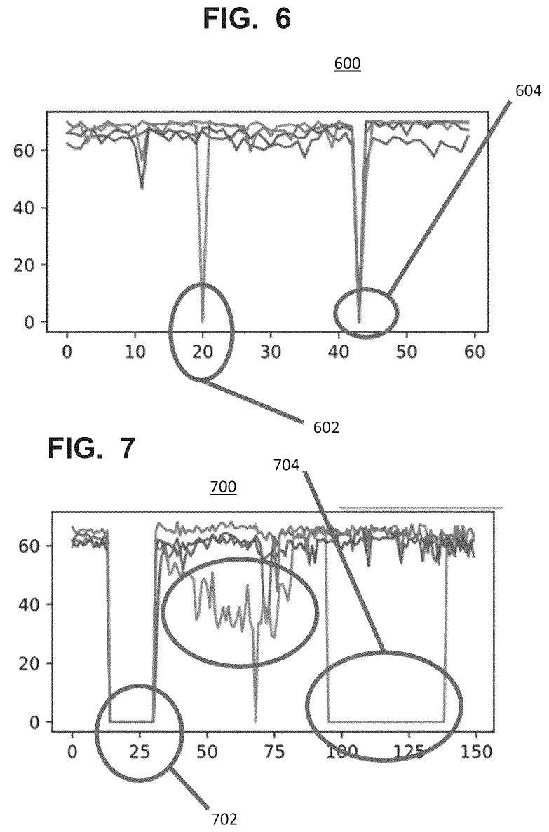

Referring to FIGS. 6-7, a chart 600 shows time mapped (x-axis) to sensor feature values (y-axis) where different lines are different sensors, Relevant here, the chart 600 shows a spatial dependency spike 602 and a temporal dependency spike 604, each occurring at a single sensor and each indicating faulty sensor data due to the outlier level of the feature value shown. Chart 700 shows an ongoing spatial dependency spike 704 for a single sensor, as well as a spike 702 with both spatial and temporal dependency since two sensors have the same spike.

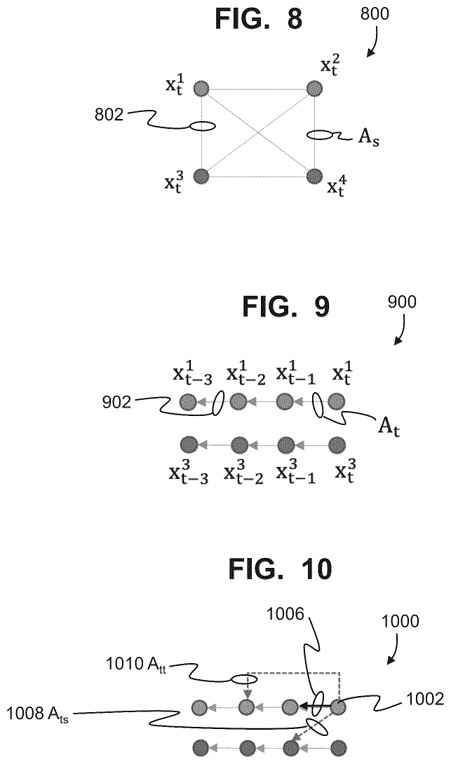

Referring to FIG. 8, a spatial sensor data dependency diagram shows a spatial input feature matrix 800 that has four sensor readings or values (or inputs) defining four nodes

$$( {x}_{t}^{i} ∈ X )$$

where each edge 802 is a dependency. The spatial input feature matrix 800 may have all sensor readings at a single time point (or single time frame) and from all sensors in the group of sensors. A spatial dependency edge 802 is each designated Aₛ herein. The sensor values may be raw sensor readings or pre-processed sensors readings as expected by the dependencies unit 400.

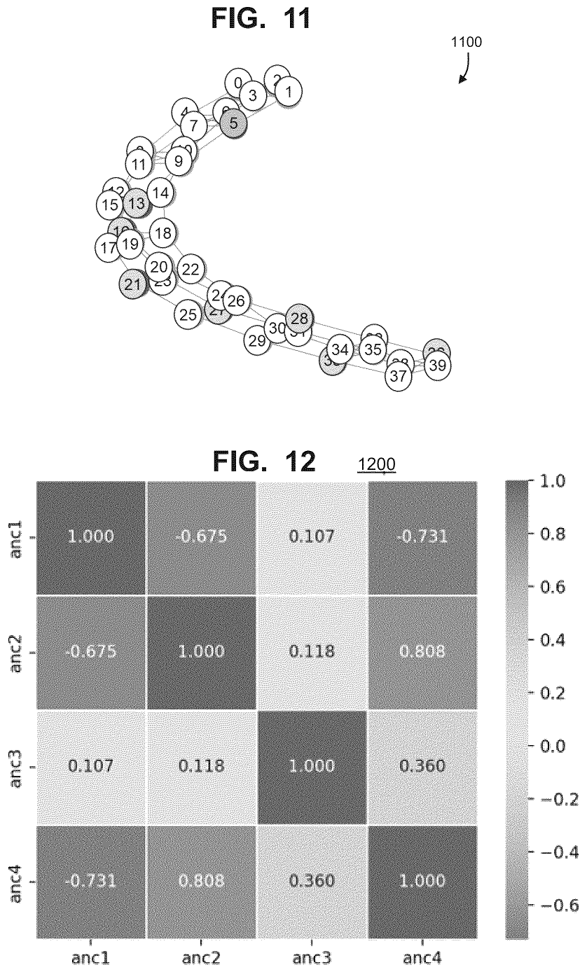

For one example implementation, the spatial dependency unit 406 computes the spatial dependencies each as a correlation between sensor readings. The following is one example equation for the correlation:

$${SA}_{f , g} = \frac{Cov ( {X}_{f} , {X}_{g} )}{δ {x}_{f} δ {x}_{g}} ∈ SA \qquad ( 2 )$$

where SA is a spatial dependency matrix, where Cov(X_{f}, X_{g}) is the covariance operation between two sensor readings, and this is determined between each available pair of sensors in the group of sensors. The variables δx_{f}, δx_{g} are each the standard deviation of each reading. The spatial dependencies are then added to a dependency graph 1100 (FIG. 11) described below and that is the graph 1100 that is to be input into the GCN 404 as represented by the dependencies in a matrix form. Thus, the spatial dependency unit 406 also may collect the sensor data to generate the spatial dependency matrix SA.

Referring to FIG. 12 for one example implementation, the spatial dependency unit 406 generates the spatial dependency matrix SA 1200 as a diagonal matrix where sensors anc1 to anc4 each having a row and column in the matrix so that each matrix element represents an available pair of sensors, and the spatial dependency matrix SA is filled with the spatial dependency values from equation (2). The grey scale indicates level of the spatial dependency value.

Referring to FIG. 9, a temporal sensor data dependency diagram shows a temporal input feature matrix 900 that has four sensor readings or values (or inputs) defining four nodes

$$( {x}_{t}^{i} ∈ X )$$

shown here for two different sensors i=1 and 3, but where all sensors I being analyzed for a group of sensors will be part of the temporal input feature matrix 900. Each sensor 1 or 3 here have four sensor readings or data values each at a different time t here being from t−3 to t. Each edge 902 is or represents a dependency, and herein a direct (or adjacent) dependency when the sensor readings (or samples) are consecutive or adjacent for a single sensor. The input feature matrix 900 may have all sensor readings within the sampling duration T and for all sensors I in the group of sensors. A temporal dependency edge 902 is designated Aₜ herein. The sensor values may be raw sensor readings or pre-processed sensors readings as expected by the dependencies unit 400.

By one example implementation, a temporal dependency matrix designated TA may be a diagonal matrix as well where the rows and columns are each a different time point within the same sampling duration T and for samples at the same time intervals t. Thus, the rows cover a same sample duration T as covered by the columns, and each row represents the same time intervals t as the intervals t on the columns as follows for a temporal dependency matrix TA for a single sensor:

$$\begin{matrix} & t 1 & t 2 & t 3 & t 4 \\ t 1 & [ [ 1. & 0.8007374 & 0.41111229 & 0.13533528 ] \\ t 2 & [ 0.8007374 & 1. & 0.8007374 & 0.41111229 ] \\ t 3 & [ 0.41111229 & 0.8007374 & 1. & 0.8007374 ] \\ t 4 & [ 0.13533528 & 0.41111229 & 0.8007374 & 1. ] ]\end{matrix}$$

where the sampling duration T is t1 to t4. The temporal dependency values are determined as follows.

For one example implementation, the temporal dependency unit 408 may compute the temporal dependencies based on Markov chain theory (or the Markov property) where more recent or present data is emphasized more than older data to set a current dependency value. Sequential dependencies in time-series data is formulated here by constructing a TA weight matrix through Gaussian probability distributions where closer readings have higher temporal influences on each other. By one example, the following computation is used:

$${TA}^{h , j} = {e}^{- \frac{{( h - j )}^{2}}{2 {δ}^{2}}} ∈ TA \qquad ( 3 )$$

where TA also is a temporal dependency matrix shown above, where h and j are two different time points (or sample times), and where the variable δ² is an uncertainty (or variance) in the temporal transition and that is a fixed hyperparameter determined during training. Thus, the temporal dependency unit 408 may collect the sensor data and generate the temporal dependency matrix TA shown above.

Referring to FIG. 10, an ST dependency diagram 1000 shows that a single sensor (or sensor data value or reading) 1002 may have multiple dependencies including both a spatial dependency and a direct temporal dependency 1006. An indirect or non-adjacent spatial dependency 1008 or Ats can occur when the dependency is to a different sensor at a different sample time. An indirect or non-adjacent temporal dependency 1010 or Aₜₜ also can exist that is a short jump in time that skips one or more sample times for the same sensor, also referred to as short-term temporal dependencies.

Referring to FIG. 11, an ST dependency graph 1100 (or just dependency graph as mentioned above) 1100 represents both the spatial and temporal dependencies and may be considered the input graph to the GCN 404. The graph 1100 includes both the nodes (numbered 0 to 39) as the sensor data values and the edges as the dependencies, whether temporal or spatial dependencies. Thus, a single sensor value on the graph 1100 may have multiple dependencies. The dependency graph 1100 may be designated as a GCN formulation where graph construction (GCN) G={X, A} where X is each instance of feature magnitudes (or sensor data) that form the graph nodes and A is the dependencies that form the graph edges.

Referring to FIG. 13, an example implementation of an ST-GCN block 1304 (or just GCN block 1304) of a GCN 1300 is the same or similar to GCN blocks 412 of GCN 404 or 112, and in a sequence of the GCN blocks from 1 to N. Shown here an intermediate GCN block n 1304 receives intermediate features Zₙ₋₁ from a previous GCN block n−1 1302 and provides intermediate features Zₙ₊₁ to a next GCN block n+1 1306.

As mentioned above, the example intermediate feature outputs Zₙ from each GCN block 1304 may be a three dimensional vector, but may be other structures as desired. Say for the continuing example here, for a time window length of five (five intervals or samples)) and a sensor group with four sensors, the intermediate feature outputs Zₙ by all of the GCN blocks 1304 will be (5 (the value five)×4 (the value four)×64) including the last GCN block N (or L) to provide a final output Z_{N} (or Z_{L}) with a feature channel of 64 features forming the feature distribution or feature map described herein. The output of any of the GCN blocks may be in the form of a vector that is represented by a 3D matrix.

One example architecture of the GCN blocks that is repeated for each GCN block including the GCN block 1304 includes, in order, a spatial (enriched) feature embedding layer 1308, a first subtractor 1310, a first graph convolutional layer 1312, a first ReLU layer 1314, a temporal (enriched) feature embedding layer 1316, a second subtractor 1318, a second graph convolutional layer 1320, and a second ReLU layer 1322.

In operation, the spatial (enriched) feature embedding layer 1308 embeds a version of the spatial dependencies (or a version of the spatial dependency matrix SA) with either (1) the output intermediate feature from a prior GCN block, or (2) a version of sensor data values used to form the spatial dependencies when the current GCN block is the first GCN block 1 (410), for example, and to form first embedded results. More specifically, the spatial feature embedding layer 1308 generates a normalized adjacency matrix Â as follows:

$$Â = {\tilde{D}}^{- 1 / 2} \tilde{A} {\tilde{D}}^{- 1 / 2} \qquad ( 4 )$$

where a spatial normalized adjacency matrix Â= [symbol] , and where Ã is the spatial dependency matrix SA, and \tilde{D} is a diagonal degree matrix where each entry dᵢ in the matrix \tilde{D} is the degree that is a sum of connection weights. The sum of connection weights is the sum of spatial dependency values on all edges of a single sensor value (or node) of the graph 1100.

Thereafter, the next example operations of the GCN block 1304 can be expressed as an equation:

$$\ddot{{Z}_{n}^{S}} = ReLU ( Conv ( ( \text{?} \cdot {Z}_{n} ) - {Z}_{n} ) ) \qquad ( 5 )$$

where equation (5) is a general equation such that Zₙ in eq. (5) is the intermediate feature output from the nth ST-GCN block (or the input feature matrix Z₁ if the GCN block is the first GCN block 1, also referred to as the sensor data). It should be noted that in this specific example of GCN block n 1304, Zₙ here would actually be Zₙ₋₁ since the previous GCN block is n−1 as shown in FIG. 13 and the output of GCN block n will be Zₙ. The spatial (enriched) feature embedding layer 1308 performs matrix multiplication from equation (5) between the normalized spatial adjacency matrix Â (or [symbol] ) and the intermediate feature output Zₙ, and specifically the feature channel having the feature map or feature distribution, or the first or original input node feature matrix (or sensor data). This results in first embedded or enriched results output from the spatial (enriched) feature embedding unit 1308.

The first subtractor 1310 then computes first differences between (1) the intermediate features from a prior GCN block (or sensor data) Zₙ used to form the spatial dependencies and (2) the first embedded results according to equation (5).

The first one or more graph convolutional layers 1312 then convolves the first differences. In the present example, a single convolutional layer processes the first differences, but many different convolutional layer arrangements may be used including a series of multiple convolutional layers. By one example, all of the convolutional layers in the GCN block 1304 are linear, and both receive and output 64 features except for the first convolutional layer of the first GCN block 1 that receives only the two features from the original input feature vector (equation (1) above) but still outputs 64 features. A bias is used by each convolutional layer as well. It will be understood that other architecture may be used when the input features are more than two.

Next, the first Rectified Linear Unit (ReLU) layer 1314 converts results from the first convolutional layer(s) to positive and generates first ReLU results designated as

$${\ddot{Z}}_{n}^{S}$$

thereby completing equation (5) above.

The temporal (enriched) feature embedding layer 1316 embeds the temporal dependencies of a temporal dependency matrix TA with the first ReLU results

$$\ddot{{Z}_{n}^{S}}$$

to form second embedded results by first using the same normalized adjacency matrix equation (4) recited above, only here Ã is the temporal dependency matrix TA. Thus, equation (4) now establishes a temporal normalized adjacency matrix Â (or [symbol] ). Thereafter, the temporal (enriched) feature embedding layer 1316 generates second embedded results by performing the matrix multiplication between the normalized adjacency matrix Â (or [symbol] ) and the first ReLU results

$${\ddot{Z}}_{n}^{S}$$

according to equation (6) below:

$${Z}_{n} = ReLU ( Conv ( ( \text{?} \cdot \ddot{{Z}_{n}^{S}} ) - \ddot{{Z}_{n}^{S}} ) ) \qquad ( 6 )$$

where Zₙ is the intermediate feature that is the output of the GCN block n 1304. The second subtractor 1318 then computes second differences between the first ReLU results

$${\ddot{Z}}_{n}^{S}$$

and the second embedded results.

A second one or more graph convolutional layers 1320 then convolves the second differences. The graph convolutional layer 1320 is as described above with graph convolutional layer 1312.

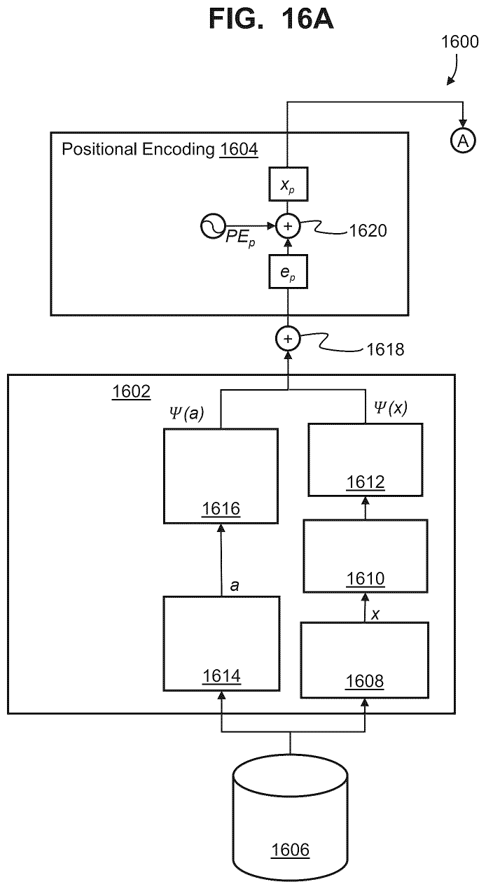

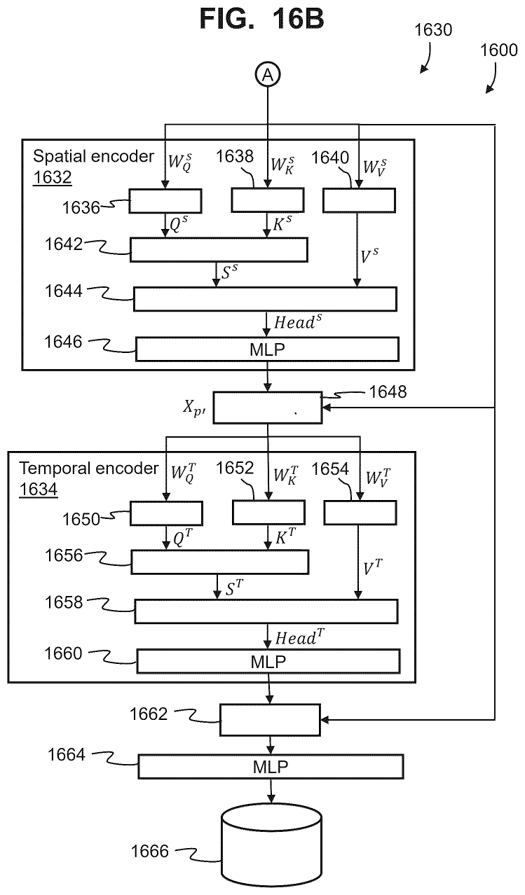

A second ReLU layer 1322 processes the results of the second convolutional layer(s) and outputs the intermediate feature Zₙ, which completes equation (6) and is then provided as input to the next GCN block n+1 1306. The intermediate feature output Z_{N} or Z_{L} of the last GCN block N 413 has the feature channel or feature distribution that indicates a faulty sensor and the source faulty sensor, and may be provided to a restoration system or network as described below with example restoration unit 206 described in detail below with FIGS. 16A-16B.

Referring now to FIG. 14, a training system 1400 includes both the faulty sensor data identification (or classifier) neural network (FS-ID-NN) 1408 (or 116) that is operated by the training faulty sensor identification unit 214, and the domain adaptive neural network DA-NN 1418 (or 118) that is operated by domain classifier unit 218. In this example, input sensor data X 1402 is provided to a series of GCN blocks 1 to N (1404 to 1406) of the GCN 1300 (or 404 or 112) where the last GCN block 1406 provides the last intermediate feature (or feature distribution or feature map) Z_{N} with 64 features as one example to both the FS-ID-NN 1408 and the DA-NN 1418.

As mentioned above, the FS-ID-NN 1408 operates on labeled data for supervised learning that is input into the GCN 1300 to generate last intermediate feature (or feature map or distribution) Z_{N}, that is in turn input to the FS-ID-NN 1408 for training of the GCN 1300. The datasets used herein for both the FS-ID-NN 1408 and DA-NN 1418 may originate from a known or publicly available dataset, or may be a customized dataset depending on the group of sensors being used. By one form, a label ID unit or control 1430 may monitor the transmission of the GCN output Z_{N} and includes automatically identifying whether the input data was labeled. If the input training data was not labeled, the label ID control 1430 directs the GCN output Z_{N} to only be provided to the DA-NN 1418 and not the FS-ID-NN 1408. This may be a manual operation as well such the FS-ID-NN simply may be turned off or transmission to the FS-ID-NN is blocked manually when semi-supervised input is loaded into the GCN 1300 for training.

By one example implementation, the FS-ID-NN 1408 may have a Multi-Layer Perceptron (MLP) 1410 that receives the GCN output Z_{N} and then outputs two probability features to a Softmax layer 1412 that in turn outputs revised probabilities that are, or are used to compute, an abnormality classification y. The MLP 1410 may have multiple fully connected layers that receives the three dimensional vector of the last intermediate feature Z_{N} from the last GCN block N 412 so that in the present example, the input to the MLP 1410 is 64 features in the feature channel. The MLP 1410 still outputs a three dimensional vector where the first two dimensions remain the same as a count of the number of time intervals (or samples) and a count of sensors in the group of sensors. The third and feature channel, however, outputs two features with one feature that represents a probability of a faulty sensor data (and a faulty sensor) and the other feature representing good sensor data (or a good sensor), and repeated so that each sensor of the group of sensors has its own three dimension vector output from the MLP 1410. By continuing the example above, the MLP 1410 may output a three dimensional vector that is 5×4×2, and that may be collected into multiple vectors to form a 2D matrix where each row or column has the two features for a different sensor.

The Softmax layer 1412 does not change the dimensions, and specifically the ‘out_feature’ dimension of the vector from the MLP 1410. Instead, the Softmax layer 1412 converts the two output features into a probability distribution with defined classes. This is accomplished by making the sum of each row or vector equal to one (such as changing the feature values to [0.99, 0.01]), and where [1,0] represent good sensor data (and in the case, of RTLS sensors, successful LOS) and [0,1] represents faulty sensor data (and in the case of RTLS sensors, a resulting NLOS situation) as one example. The two features may be provided as two bits (01 or 10), and when desired, converted into a single classification y 1414. The output of the FS-ID-NN 1408 still may be in the form of the three dimensional vector (m×I×2).

At a ground truth (GT) loss unit 1414, both the two-feature input probabilities to the Softmax layer 1412 and the binary feature output of the Softmax layer 1412 may be used in a known or other loss function (such as categorical cross-entropy as one example) to generate a backpropagation ground truth loss L_{c} and gradient ∂L_{c}/δθ_{Zn} that has θ as a weight parameter and with regard to the MLP-Softmax output. This then may be converted to a gradient with regard to the weights of the GCN 404 (or 1300) of ∂L_{c}/∂θ_{Zn} to modify the weights of the GCN 404. This is used for backpropagation 1426 as shown. The output of the Softmax layer 1412 also may be provided as the abnormality classification y.

For the adaptive domain training, the DA-NN 1418 is used to train the GCN backbone NN 1300 to produce consistent and similar feature distributions regardless of different scenarios (or domains) and by training the GCN 1300 to find hidden “domain-independent” correlations among the sensor data of the group of sensors and by using a DA-NN 1418 (or domain classification network) with a dynamic, adaptively increasing lambda.

Specifically here, a gradient reversal unit or layer 1416 first receives the last intermediate feature (or feature map or distribution) Z_{N} and may be considered to simply forward the input vector, including the 64 feature channel and the three dimensional vectors (m×I×64), to the DA-NN 1418 unchanged. The gradient reversal layer 1416 is shown as a place holder in forward propagation for neural network framework graphs, but is to be applied during backpropagation 1428 and as explained below.

The DA-NN 1418 may have an MLP 1420 and a Softmax layer 1422 to accept both labeled and unlabeled training data. The unlabeled data includes environment or domain variations (or cross-domains) for the same group of sensors providing the sensor data. Such domains for RTLS localization for sensors on a car may include outdoor, indoor, garage, and parking lot domains to name a few examples in addition to any of those domains mentioned above. While the domains are both unlabeled and labeled for semi-supervised training, the system can track which domain is being processed anyway since the domain of the input for the training is likely to be known. The domains are provided as source and target domains, where the DA-NN attempts to classify the domain as a target or source domain, and generates domain classification d indicating the results of the classification. The source domains are the initial or original first domains the DA-NN is originally trained on, while the target or cross domains are the domains the DA-NN is trying to generalize to.

Specifically, the MLP 1420 layer receives a 64 feature channel of the intermediate feature Z_{N} and outputs a two feature vector of each input domain, where one of the two features is an indication of a likelihood of a source domain and the other feature is a likelihood of a target domain. The Softmax layer 1422 converts the features into probabilities as mentioned above with Softmax layer 1412 so that the two features are provided as [1,0] for a source domain and [0,1] for a target domain. The output from the Softmax layer 1422 may be the three dimensional vector (as a matrix when desired) such as (m×I×2).

The DA loss unit 1424 then generates a domain-adaptive loss L_{D} by using the classification d (for unlabeled or labeled semi-supervised training). The domain-adaptive loss LD encourages the GCN 1300 to be domain-invariant so that the GCN 1300 does not just rely on specific features of the source domain but generalizes well to the target domain too. This makes the GCN 1300 better at transferring knowledge from one domain (the source) to another (the target) despite differences in their data distributions. The loss LD may be computed by using an example binary cross-entropy equation that factors both the source and target domain probabilities, although other equations may be used.

Once the loss L_{D} is computed, a domain adaptive training parameter (or weight factor) λ (or just parameter λ) is applied to the loss L_{D} for backpropagation 1128 to control the strength of the domain loss. Thus, the parameter λ is a hyperparameter gradually increased during training. Thus, early in the training, parameter λ should be small or close to negative so that the GCN focuses more on fitting to the source domain. The domain adaptation loss is weak at this point. About mid-way through training and as parameter λ increases, the domain adaptation loss is stronger, and the GCN focuses more attention to aligning the source and target domains, helping it become more domain-invariant. Late in training, parameter λ becomes larger and positive so that the GCN 1300 has learned much of the source domain knowledge, and now starts focusing heavily on minimizing the domain shift, ensuring that the GCN 1300 generalizes well to the target domain.

The parameter λ can be adjusted during training as explained as follows. Given that the source and target domain inputs share the same dependency graph structure, with differences only in node values (input features), the adaptation strength should dynamically adjust based on the degree of domain shift.

The parameter λ should be correlated with both key domain shift indicators and training progress, where a stronger domain shift necessitates a higher contribution from domain loss to ensure effective adaptation. The parameter λ may be computed as follows:

$$λ ( p ) = ( \frac{2}{1 + {e}^{- 10 p}} - 1 ) * s \qquad ( 7 )$$

where p is the training iteration determined by:

$$p = \frac{current step}{total step} \qquad ( 8 )$$

where the total step is the total number of steps (or iterations) in the training progress. The variable s is a scaling factor that adjusts the overall strength of the domain adaptation loss and is related to the domain shift (how much difference there is between the source and target domains) and the degree of domain discrepancy. When the domain shift is large, a stronger adaptation loss is helpful for the GCN 1300 to learn how to adapt better to the target domain. When the domain shift is smaller, a reduced strength of the adaptation avoids overfitting to the target domain. Thus, the scale factor ‘s’ here is an estimated maximum mean discrepancy (MMD) and that is a quantification of a distribution difference between the source and target domains computed as follows:

$${MMD}^{2} ( {X}_{s} , {X}_{i} ) = 𝔼 [ k ( {X}_{s} , {X}_{s} ) ] - 2 𝔼 [ k ( {X}_{s} , {X}_{i} ) ] + 𝔼 [ k ( {X}_{t} , {X}_{i} ) ] \qquad ( 9 )$$

where k is a kernel function (e.g., RBF kernel), [symbol] [ ] is expected value (such as a weighted average or other combination operation), Xₛ is a source domain sensor value, and Xₜ is a corresponding target domain sensor value. A higher MMD score suggests greater distribution shift.

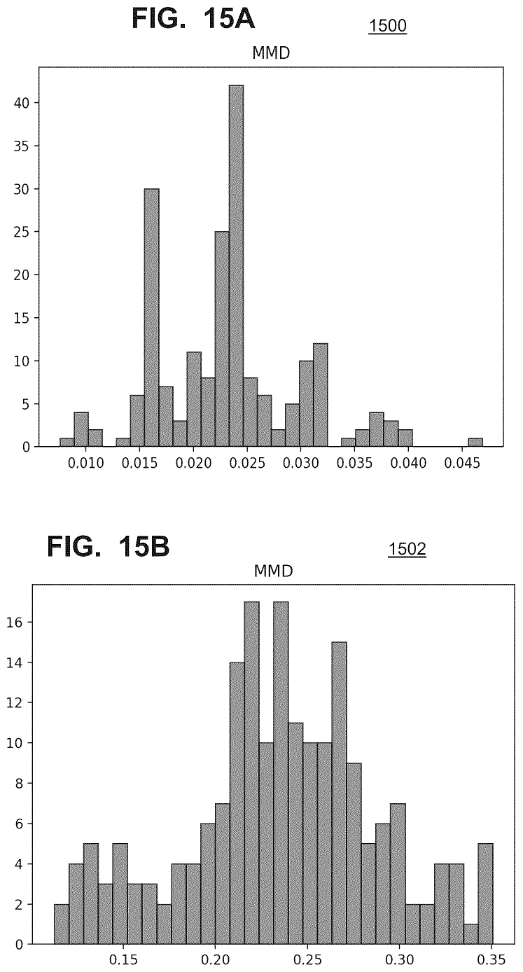

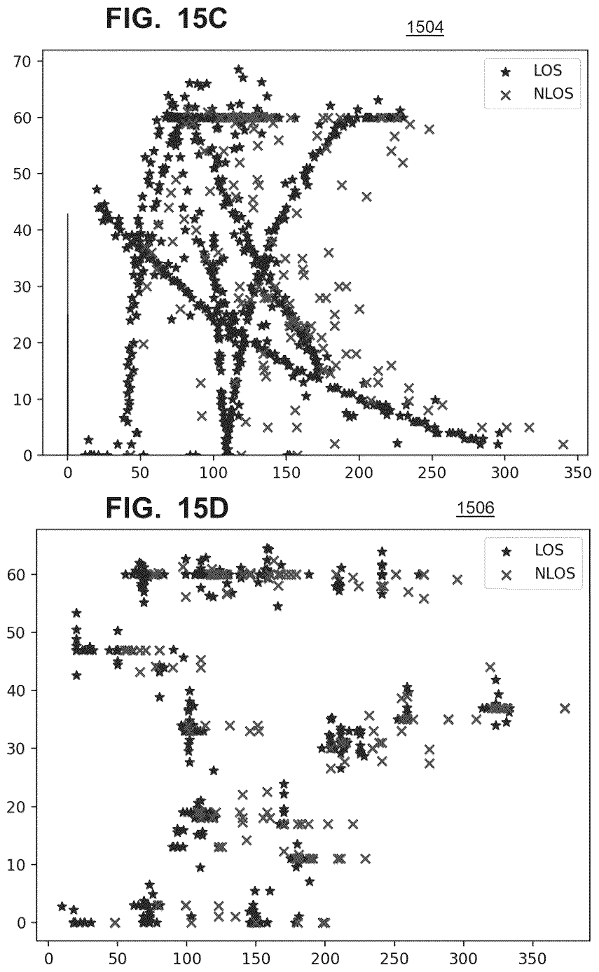

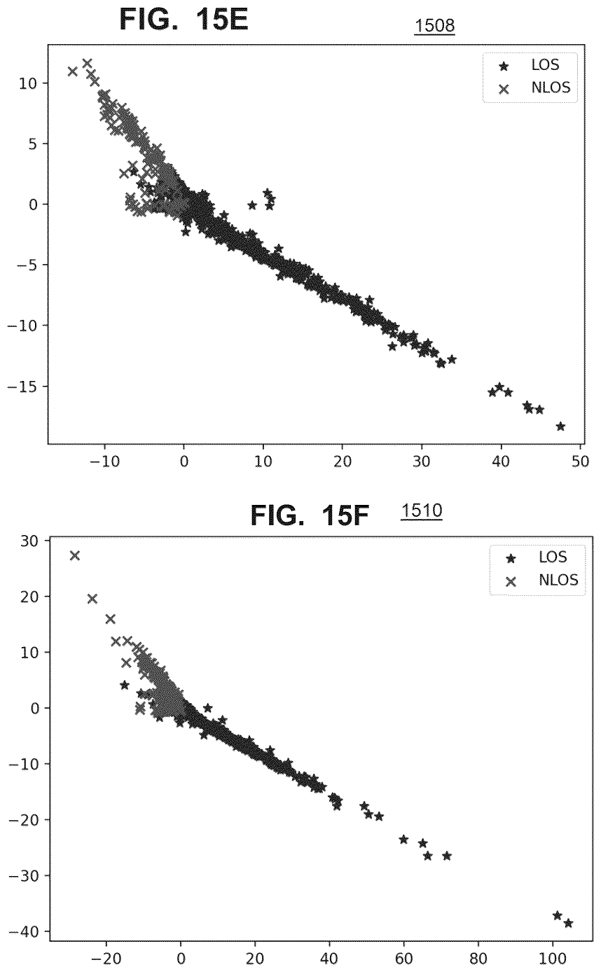

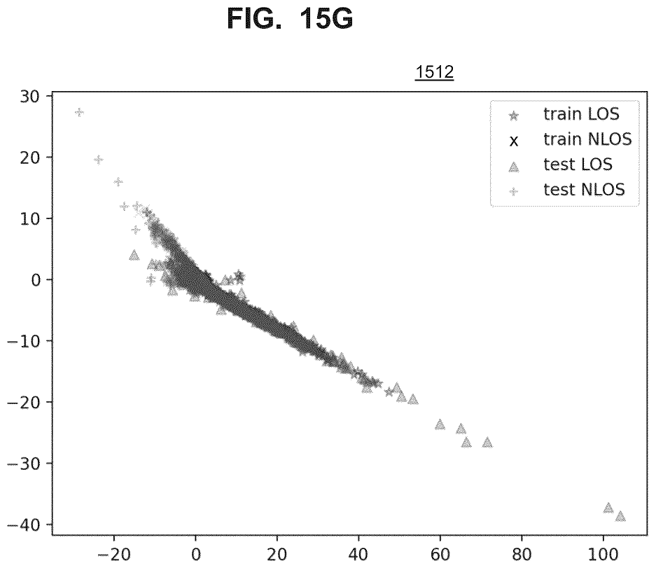

Referring to FIGS. 15A-15G, graphs are provided to show the domain shifts and feature distribution convergence due to training. MMD domain shift indicator charts are shown as a histogram 1500 (FIG. 15A) that shows MMD values along the x-axis mapped to normalization of sensor data feature values on the y-axis for a source domain. An MMD histogram 1502 (FIG. 15B) shows MMD values mapped to normalized sensor data feature values for a target domain indicating noticeable differences between the two domains.

A graph 1504 (FIG. 15C) and a graph 1506 (FIG. 15 D) respectively for source and target domains show input distributions where stars indicate good sensor data (and good sensors also referred to as LOS data when the domains are for RTLS localization) while an x indicates faulty sensor data (and a faulty sensor also referred to as NLOS when the domains are for RTLS localization). The y-axis indicates one feature value (such as AOA for the RTLS localization), while the x-axis provides another feature value (such as TOA for the RTLS localization). The graphs 504 and 506 show large differences between the source and target domain input distributions.

A graph 1508 (FIG. 15E) and a graph 1510 (FIG. 15 F) respectively for source and target domains show feature distributions generated as the intermediate feature maps (from a middle GCN block before the last GCN block N 413) where stars indicate good sensor data (and good sensors also referred to as LOS data when the domains are for RTLS localization), while an x indicates faulty sensor data (and a faulty sensor also referred to as NLOS when the domains are for RTLS localization). The y-axis indicates feature value while the x-axis is a unitless scale used for mapping the feature distribution. The graphs 1508 and 1510 show the feature distributions are now much closer to each other due to the processing at the GCN.

A graph 1512 shows the feature distributions as the final output from the GCN are now strikingly similar where a trained (or source) domain shows a feature distribution with good (or LOS) sensor data as stars, and bad (or NLOS) sensor data as x, and a test (or target) domain with a feature distribution with good (or LOS) sensor data as triangles, and bad (or NLOS) sensor data as a plus shape. The feature distributions now substantially overlap and cannot be significantly differentiated, thereby indicating the feature distributions largely show domain-independent features for faulty sensor identification.

Referring again to FIG. 14, and returning to the back propagation of the domain loss L_{D}, the DA loss unit 1424 (or other unit) may generate gradients for backpropagation 1428 and to be applied to the GCN 1300, as with GT loss unit 1414 already described above, but here where the gradient is designated as:

$$λ \frac{\partial {L}_{D}}{\partial {θ}_{d}} \qquad ( 10 )$$

Thereafter the gradient is provided to the gradient reversal layer 1416 to modify the parameter λ and specifically by reversing the sign of the gradients (or parameter λ) to make it negative or positive from whichever it is originally. It can also be considered that the parameter λ controls the strength of the gradient reversal. The resulting negative domain loss gradient is also adjusted according to the feature values or probability values of the MLP 1420 as explained above with the ground truth loss, and the result is a gradient of:

$$- λ \frac{\partial {L}_{D}}{\partial {θ}_{{z}_{n}}} \qquad ( 11 )$$

By applying the negative gradients to the GCN block layers, the negative gradients force the GCN to make two parts of the GCN compete against each other by reversing the gradient direction. Thus, this introduces an adversarial signal that forces one part of the network to become more invariant or resilient to certain features (e.g., domain-specific characteristics or biases). As a result, the GCN 1300 learns features that are invariant to domain-specific differences.

Thereafter, the domain-adaptive loss L_{D} subsequently may be combined with the ground truth loss L_{c} to determine a total loss L to be applied to the weights of the GCN 1300 as one example. In some examples, total loss L may be in terms of the loss itself (12a) or the gradients (12b) for application of a single gradient to the weights of the GCN:

$$L = {L}_{c} + λ {L}_{d} \qquad ( 12 a )$$

$$\frac{\partial L}{\partial {θ}_{{z}_{n}}} = \frac{\partial {L}_{C}}{\partial {θ}_{{z}_{n}}} + - λ \frac{\partial {L}_{D}}{\partial {θ}_{{z}_{n}}} \qquad ( 12 b )$$

Alternatively, the losses L_{c} and L_{D} may be combined by other techniques, such as an average or other combinations to apply a single gradient weight factor to the weights of the GCN 1300.

The following is example pseudo code that may be used for the entire network during training showing layer specifications:

```
DA-NN GCN(
  (gcn_blockl_spa): GCNLayer(
    (linear): Linear(in_features=2, out_features=64, bias=True)
  )
  (gcn_blockl_tem): GCNLayer(
    (linear): Linear(in_features=64, out_features=64, bias=True)
  )
  (gcn_block2_spa): GCNLayer(
    (linear): Linear(in_features=64, out_features=64, bias=True)
  )
  (gcn_block2_tem): GCNLayer(
    (linear): Linear(in_features=64, out_features=64, bias=True)
  )
  (gcn_block3_spa): GCNLayer(
    (linear): Linear(in_features=64, out_features=64, bias=True)
  )
  (gcn_block3_tem): GCNLayer(
    (linear): Linear(in_features=64, out_features=64, bias=True)
  )
  (gcn_block4_spa): GCNLayer(
    (linear): Linear(in_features=64, out_features=64, bias=True)
  )
  (gcn_block4_tem): GCNLayer(
    (linear): Linear(in_features=64, out_features=64, bias=True)
  )
  (NLOS_classifier): Sequential(
    (0): Linear(in_features=64, out_features=2, bias=True)
    (1): Softmax(dim=1)
  )
  (domain_classifier): Sequential(
    (0): GradientReversallayer( )
    (1): Linear(in_features=64, out_features=64, bias=True)
    (2): MLP( )
    (3): Linear(in_features=64, out_features=2, bias=True)
    (4): Softmax(dim=1)
  )
)
```

The following is example Python code for PyTorch pseudo code defining the GCN architecture:

```
Class GCNLayer(nn.Module):
  def _init_(self, in_features, out_features):
    super(GCNLayer, self)._init_( )
    self.linear = nn.Linear(in_features, out_features)
  def forward(self, A, X):
    D = torch.diag(torch.sum(A, dim=l))
    D_inv_sqrt = torch.tinatg.inv(torch.sqrt(D))
    A_hat = D_inv_sqrt @ A @ D_inv_sqrt
    hid= A_hat @ X # [4, 2]
    hid = X-hid
    out = self.linear(hid)
    out = F.relu(out)
    return out
```

Referring now to FIGS. 16A-16B, an example faulty sensor data denoising or restoration system 1600 (or unit 206) has a multi-variant embedding segment 1602 and a positional encoding segment or unit 1604. The segments 1602 and 1604 may be referred to together as the input encoding branch. The output of the positional encoding segment 1604 is provided to a multi-attention signal restoration neural network (or just restoration NN or NN branch) 1630 and that has a spatial encoder 1632 and a temporal encoder 1634.

The embedding segment 1602 may include some overlap with the GCN operation including obtaining sensor readings, except here this is shown as receiving the sensor readings from a sensor reading database 1606 or alternatively from the sensors or sensor analysis units directly. An ST-GCN abnormality detection unit 1614 operates the GCN as described above or other faulty sensor data detection algorithms to identify faulty sensor data ‘a’ that may in the form of a feature distribution that indicate corresponding raw sensor data (such as two input features AOA and TOA for RTLS localization) have at least one faulty sensor value. Separately, a raw input processing unit 1608 may pre-process raw sensor data to expected formats to generate sensor data or values ‘x’. A quantization unit 1610 then scales the raw sensor values x so that the sensor data input and the abnormality features (or feature distribution) will have data bit sizes that can be placed together in a single word after separate embedding.

Thus, the feature distributions a and the quantized sensor data x (designated vₓ) are respectively provided to an input embedding unit 1612 and an abnormality feature embedding unit 1616 that both perform separate embedding to the feature distributions a and the quantized sensor data x (or vₓ). The embedding here may be similar to encoding and for the abnormality features performs a linear transformation, which may be by matrix multiplication, to change the dimensionality of the abnormality features a. In the current example for the sensor data vₓ, the sensor data embedding is based on a value range of the quantized sensor data vₓ instead of matrix multiplication. The resulting embeddings of the abnormality features from the GCN is designated ψ(x) and the embeddings of the sensor data is designated ψ(a).

Thereafter by one implementation, positional encoding may be performed by positional encoding unit 1604 since the transformer NN 1630 cannot track input or token order itself. The positional encoding adds position information to the data so that the transformer NN 1630 can track a sequence of words of the embeddings data. In this example, the addition operator 1618 combines the abnormality and sensor data embeddings ψ(x) and ψ(a) to form a multi-variant embedding word ep. By one example, the embeddings are combined by concatenation to form a vector although other structures may be used instead.

For a token (or word) at position p in a sequence of the words, the positional encoding function PEₚ is computed using sine and cosine functions:

$${PE}_{p , 2 i} = sin ( \frac{p}{{L}^{2 i / κ}} ) {PE}_{p , 2 i + 1} = cos ( \frac{p}{{L}^{2 i / κ}} ) \qquad ( 13 )$$

where L is a scaling factor, K is total dimensionality of the embedding space, and i here is the dimension index (or coordinates) of an embedding vector. The transformer embedding space may have a fixed size of 512, 768, or 1024 dimensions as some examples.

Thus, the final input embedding is defined as: xₚ which can be determined as:

$${x}_{p} = {e}_{p} + {PE}_{p} \qquad ( 14 )$$

In the present example, each xₚ from the positional encoding is a three dimensional vector that includes position information for the words in a sequence of the words. The vector may be in the form of one dimension for spatial position (e.g., sensor id), one for temporal position (e.g., time step), and one additional dimension for number of input features including raw sensor readings (e.g., ToA, AoA) and all features provided by the GCN feature embedding backbone network. The PE values describe the token's absolute position and implicitly encode the relative distance between tokens.

Turning now to the transformer NN 1630, the three dimensional vector is provided to three different places in the transformer NN 1630 including the input to the spatial encoder 1632, a concatenation unit or layer 1648 that also receives output from the spatial encoder 1632, and an ST vector unit or layer 1662 that also receives output from the temporal encoder 1634, and each is described below in turn.

The spatial encoder 1632 has three linear layers 1636, 1638, and 1640 that respectively have learnable weight matrices

$${W}_{Q}^{s} , {W}_{k}^{s} , {W}_{v}^{s} ,$$

and where superscript s stands for spatial. The xₚ input is provided to each linear layer 1636, 1638, and 1640. The output of the linear layers 1636, 1638, and 1640 is a query Q^{S}, key K^{S}, and value V^{S} matching the designations on the weight matrices. Query (Q) refers to a current token, key (K) refers to other tokens being compared against, and value (V) refers to the content being aggregated (the sensor values and abnormality features). The spatial encoder 1632 also has a scaled dot product layer 1642 that determines the similarity of the Q^{S} and the K^{S} from the linear layers 1636 and 1638 by using a dot product and to output a scaled dot-product attention score S^{S}.

Both the spatial and temporal encoders 1632 and 1634 have a hierarchical multi-head attention structure. Thus, after S^{S} and V^{S} are obtained in the spatial encoder 1632, a MatMul and Softmax layer 1644 performs a spatial head equation heads for the spatial domain to attend to spatial relationships among sensors as follows:

$${head}^{s} ( {Q}^{s} , {V}^{s} , {K}^{s} ) = SoftMax ( \frac{{Q}^{s} * {( {K}^{s} )}^{T}}{\sqrt{κ}} * {V}^{s} ) \qquad ( 15 )$$

where * is matrix multiplication. The head equation head^{S} (15) captures relationships such as the spatial dependencies between different parts of the input sequences, and the Softmax operation provides probabilities of those relationships.

The head^{S} is then provided to an MLP layer 1646 to assist with capturing complex patterns by providing non-linear transformations and feature mixing including dimensional expansion. The output of the MLP layer 1646 also is the output of the spatial encoder 1632 and is then provided to the concatenation unit or layer 1648 that also directly receives the xₚ input.

The concatenation unit 1648 concatenates each xₚ to form a matrix X_{p′} and keeps concatenating the received data to form a 2D surface thereby continuously expanding the dimensions of X_{p′}.

As to the temporal encoder 1634, the structure is basically the same or similar to that of the spatial encoder. Here, three linear layers 1650, 1652, and 1654 receive the matrix X_{p′} Otherwise, the operation with Q, K, and V, including a head^{T} equation, is the same except designations are with a T for temporal rather than the S for spatial, and need not be described again. The output of the temporal encoder 1634 is provided to a spatial-temporal (ST) vector unit or layer 1662 that also directly receives the xₚ input vectors to generate concatenated k-dimensional feature vectors with both the xₚ input and the output from the temporal encoder 1634.

Finally as one example implementation, an MLP layer 1664 may have two feed-forward layers that take the κ-dimensional feature vector as input and transforms the feature vector into a one-dimensional output \tilde{x} representing the restored or clean (or denoised) sensor reading as the final output.

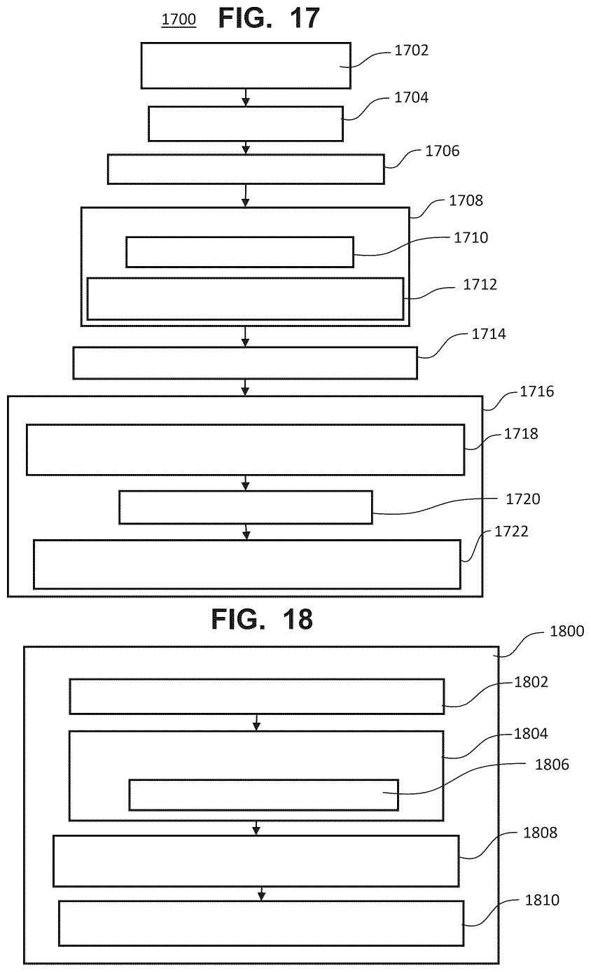

Referring to FIG. 17, an example process 1700 of detecting faulty sensor data and restoring the sensor data is shown according to at least one of the implementations herein. Process 1700 has operations 1702 to 1722 generally numbered evenly. Any of the devices, systems, and neural networks disclosed herein at FIGS. 1-16B may be referred to in order to explain process 1700.

Process 1700 may include “group contributing sensors for common goal” 1702, where the common goal is as defined above where a sensor may contribute directly or indirectly to determining a score, detecting an object, and so forth, and the identified sensors form a group of sensors for the faulty sensor detection described herein. Once the sensors are identified, process 1700 may include “receive sensor data” 1704, where the sensor data from the group of sensors is collected for the faulty sensor analysis. This also includes formatting the sensor data into a sequential data array of time versus sensor that is converted into input feature vectors.

Process 1700 may include “generate sensor data dependencies” 1706, where spatial dependencies and temporal dependencies are determined as correlations between sensor readings or data as described above using a covariance equation (2) to determine spatial dependency and a Markov chain theory (or Gaussian probability distribution) to determine temporal dependency in equation (3). The dependencies are formed into the spatial and temporal matrices.

Process 1700 may include “generate GCN backbone feature outputs” 1708, and this operation 1708 may include “iterate through N GCN blocks” 1710. Where the GCN blocks have the same structure as described above. Operation 1708 may include “input spatial and temporal dependencies into separate layers” 1712 where the spatial matrix is input to a spatial enriched feature embedding layer that receives both the spatial dependency matrix and either the output from a previous adjacent GCN block or the input sensor data. A normalization adjacency matrix (eq. (4)) is generated for the spatial dependency matrix and then multiplied by either the output from a previous adjacent GCN block or the input sensor data, whichever is present for the current GCN block (eq. (5)), and the product is then differenced from either the output from a previous adjacent GCN block or the input sensor data. The result is input to one or more convolutional layers and ReLU is applied to the convolved results. This process is repeated for a temporal enriched feature embedding layer that receives the temporal dependency matrix to multiply the normalized temporal adjacency matrix with the output spatial results as explained above with GCN block n (FIG. 13).

Process 1700 may include “identify faulty sensors” 1714, where the GCN block operation is repeated for each GCN block where each GCN block outputs an intermediate feature, and the output of the last GCN block provides a feature channel with a feature map or distribution, by one example being 64 feature values. The feature distribution or map indicates whether a sensor has faulty sensor data. A classifier system or end application may receive the feature map and can determine if faulty sensor data exists for a sensor.

Otherwise, process 1700 may include “perform sensor data restoration” 1716, and this may include “combine separately embedded sensor input data with embedded sensor abnormality feature outputs to form combined data” 1718, and where linear embedding is applied to the abnormality data indicating faulty sensor data, while the sensor data is quantized and then embedded over a range of the quantized data values. The embeddings are then combined by concatenating.

Operation 1716 may include “perform positional encoding” 1720 that is then performed to convert the combined embeddings into input for a multi-attention transformer, and by one example, where the input is the form of a three dimensional vector including the spatial position of the sensor, a temporal position in time (or time step), and the feature value or values. A token position of the vector may be implicitly encoded into the vector to indicate relative position between tokens.

Operation 1716 may include “perform spatial and temporal encoding on a multi-attention transformer-based signal denoiser” 1722. Specifically, the vectors or a set of the vectors as a 2D input may be provided to the multi-attention transformer neural network that has a spatial encoder and temporal encoder. The input vectors are placed at the input of the spatial encoder, a concatenation unit at the output of the spatial encoder and as concatenated input to the temporal encoder, and lastly to a vector unit before an MLP generates clean (or restored or replacement) sensor data for the faulty sensor data.

Referring to FIG. 18 an example process 1800 of training the neural networks of process 1700 is shown according to at least one of the implementations herein. Process 1800 has operations 1802 to 1810 generally numbered evenly. Any of the devices, systems, diagrams, graphs, charts, and neural networks disclosed herein at FIGS. 1-16B may be referred to in order to explain process 1800.

Process 1800 may include “classify domain of sensor data using a domain NN” 1802, and where the domain adaptive neural network (DA-NN) determines whether a domain is a source domain or a target domain. The DA-NN uses an MLP layer and a Softmax layer to output the domain classification using both labeled and unlabeled training data to perform semi-supervised learning. A domain loss is then computed using the domain classification, and a domain loss gradient (equation (10) above) is computed using the domain loss.

Process 1800 may include “adjust domain loss gradient with a dynamic training parameter to adjust weights of the GCN” 1804. This refers to the computation of the domain adaptive training parameter (or weight factor) λ according to equation (7) above that factors both the training progress and domain shift (or domain discrepancy).

Adjusting the domain loss gradient also may include “perform gradient reversal” 1806, where the parameter λ is made negative (or has its sign changed) by the gradient reversal layer described above to control the strength of the domain loss, and in turn the domain loss gradient.

Process 1800 may include “determine ground truth loss by using a faulty sensor ID neural network to adjust weights of the GCN” 1808. Here, the FS-ID-NN performs supervised learning with labeled training datasets to determine a fault and no fault classifications that are used to form a ground truth loss.

Process 1800 may include “adjust GCN weights by using both domain loss and ground truth loss” 1810. Here, both the ground truth gradient and the domain loss gradient are used for backpropagation and to apply to the weights of the GCN layers. This may be performed by first combining the losses by equation (12a) or by similarly combining the ground truth gradient and the domain loss gradient (equation 12b) before applying them to the weights of the layers of the GCN.

Results of the disclosed system and method provided significant improvement in faulty sensor detection with multiple domains. Test runs were performed using the RTLS sensors for localization on the vehicle as with FIG. 3, and where faulty sensor detection is referred to as NLOS detection. A trained or source domain was tested with labeled data in supervised learning for the FS-ID-NN as well as a cross or target domain with both labeled and unlabeled data in semi-supervised learning for a DA-NN.

It was found that the trained domain had the following results: accuracy: 94.75%, precision: 94.39%, recall: 99.38%, and F1-score (or harmonic mean of precision and recall): 96.83%. The cross domain had the following results: accuracy: 88.63%, precision: 91.55%, recall: 94.30%, and F1-score: 92.90%.

Herein, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connected” or “coupled to” used in describing a relationship between different elements or parts of the nozzle do not imply that a direct physical connection must be made between these elements, unless mentioned otherwise. For example, two elements may be connected to each other physically, electronically, logically, or in any other manner, through one or more additional elements.

While at least one example implementation has been presented in the foregoing detailed description, it should be appreciated that a vast number of variations exist. It should also be appreciated that the example implementations are not intended to limit the scope, applicability, or configuration of the disclosure in any way. Rather, the foregoing detailed description will provide those skilled in the art with a convenient road map for implementing the example implementations. It should be understood that various changes can be made in the function and arrangement of elements without departing from the scope of the disclosure as set forth in the appended claims and the legal equivalents thereof.

What is claimed is:

1. A method comprising:
receiving, by at least one processor, sensor data from a group of sensors including real time location sensors used to perform localization of an object;
determining, by at least one processor, temporal dependencies of sensor data from the same sensor, repeated for multiple sensors, from the group of sensors, and spatial dependencies among sensor data from different sensors from the group of sensors;
generating, by at least one processor, indicators that indicate whether sensor data associated with individual sensors of the group of sensors is faulty sensor data comprising inputting the spatial and temporal dependencies into a convolutional neural network (CNN);
restoring the faulty sensor data to non-faulty sensor data and comprising combining a version of the indicators with a version of the sensor data associated with the indicators to generate combined fault data; and inputting the combined fault data into a multi-attention transformer neural network; and
performing the localization using the non-faulty sensor data to find a location of the object.

2. The method of claim 1, wherein the non-faulty sensor data is distance readings, and wherein the localization comprises using locations of the real time location sensors and the distance readings to perform trilateration by applying a least squares function or a density-based spatial clustering of applications with noise (DBSCAN) function.

3. The method of claim 1, comprising formatting the spatial dependencies into a spatial diagonal matrix with spatial dependency values in the spatial diagonal matrix to show a dependency among each available pair of sensors of the group of sensors; and inputting the spatial diagonal matrix into the CNN.

4. The method of claim 1, comprising formatting the temporal dependencies into a temporal diagonal matrix with temporal dependency values in the temporal diagonal matrix to show a dependency among each available pair of different sample time points for a single sensor of the group of sensors, and repeated for multiple sensors, and inputting the temporal diagonal matrix into the CNN.

5. The method of claim 1, wherein the CNN comprises a sequence of multiple CNN blocks that are repeated neural network blocks having the same neural network structure to define a number of iterations and output intermediate features at each CNN block, wherein output of each block are intermediate features and are each a three dimensional vector including a first channel of a number of samples over time obtained for the group of sensors, a second channel of a number of sensors in the group of sensors, and a third channel being a feature channel with the indicators in a form of multiple feature values that cooperatively from a feature map and that indicate a feature distribution, wherein the CNN is trained so that different output feature distributions from the CNN indicate faulty data of different sensors.

6. The method of claim 1, comprising training the CNN comprising inputting the indicators output from the CNN into both a faulty sensor data classifier neural network and a domain-adaptive neural network (DA-NN), wherein the faulty sensor data classifier neural network only operates with labeled training data and the DA-NN operates with both labeled and unlabeled training data.

7. The method of claim 6, wherein the training comprises the DA-NN generating a dynamic weighting factor for a domain adaptive loss used to modify weights of the CNN, wherein the dynamic weighting factor depends on a distribution difference quantity that is a difference between a source and target domain.

8. The method of claim 6, wherein the distribution difference quantity is determined by using Maximum Mean Discrepancy (MMD).

9. The method of claim 6, wherein the distribution difference quantity is determined by using radial basis function (RBF) kernels.

10. The method of claim 6, comprising using both a ground truth loss from the faulty sensor data classifier neural network and a domain adaptive loss from the DA-NN to modify weights of the CNN.

11. A system, comprising:
memory,
processor circuitry forming at least one processor communicatively coupled to the memory and being arranged to operate by:
receiving sensor data from a group of sensors including real time location sensors used to perform localization of an object;
determining temporal dependencies of sensor data from the same sensor, repeated for multiple sensors, from the group of sensors, and spatial dependencies among sensor data from different sensors from the group of sensors;
generating indicators that indicate whether sensor data associated with individual sensors of the group of sensors is faulty sensor data comprising inputting the spatial and temporal dependencies into a convolutional neural network (CNN);
restoring the faulty sensor data to non-faulty sensor data and comprising combining a version of the indicators with a version of the sensor data associated with the indicators to generate combined fault data, and inputting the combined fault data into a multi-attention transformer neural network;
performing a monitoring task comprising using the non-faulty sensor data; and
pre-training the CNN comprising providing the indicators to both a faulty sensor data classifier neural network and a domain adaptive neural network (DA-NN) arranged to increase generalization of the CNN to cross-domains with the same group of sensors but with different environments from domain to domain affecting the same group of sensors.

12. The system of claim 10, wherein the monitoring task is related to health monitoring with multiple different types of sensors in the group of sensors including at least for heart monitoring and human body motion to cooperatively generate a health score.

13. The system of claim 10, wherein the monitoring task is related to at least one of: navigation, vehicle performance and maintenance, health monitoring of living beings, traffic, weather, industrial machinery, residential, commercial, and industrial buildings, utility systems, and appliances, computers, computing devices, and mobile devices, industrial machinery, environmental conditions, security, occupancy, noise levels, light intensity, water usage, gas detection, smoke detection, vibrations, structural integrity, waste management, alert systems, asset tracking, worker safety, resource allocation, manufacturing processes, energy efficiency, cooling systems, machine status, and device authentication.

14. The system of claim 10, wherein at least one sensor of the group of sensors has multiple dependencies including both temporal and spatial dependencies.

15. The system of claim 10, wherein the CNN comprises multiple blocks that is a repeated neural network block used for multiple iterations, wherein each block has, in order:
a spatial feature embedding layer that embeds the spatial dependencies with either (1) output intermediate features from a prior block, or (2) sensor data values used to form the spatial dependencies, and to form a spatial enriched features,
a first subtractor to compute first differences between (1) either the output intermediate features from a previous block or the sensor data and (2) values of the spatial enriched features,
a first one or more convolutional layers using the first differences,
a first Rectified Linear Unit (ReLU) layer using results from the first one or more convolutional layers and to form first ReLU results,
a temporal feature embedding layer that receives the temporal dependencies and embeds the temporal dependencies with the first ReLU results to generate temporal enriched features,
a second subtractor that computes second differences between the first ReLU results and the temporal enriched features,
a second one or more convolutional layers using the temporal enriched features, and
a second ReLU layer that uses the results of the second one or more convolutional layer(s) and outputs next intermediate features.

16. At least one non-transitory computer-readable medium comprising instructions thereon that when executed by a computing device, cause the computing device to operate by:
receiving sensor data from a group of sensors including real time location sensors used to perform localization of an object;
determining temporal dependencies of sensor data from the same sensor, repeated for multiple sensors, from the group of sensors, and spatial dependencies among sensor data from different sensors from the group of sensors;
generating indicators that indicate whether sensor data associated with individual sensors of the group of sensors is faulty sensor data comprising inputting the spatial and temporal dependencies into a convolutional neural network (CNN);
restoring the faulty sensor data to non-faulty sensor data and comprising combining a version of the indicators with a version of the sensor data associated with the indicators to generate combined fault data, and inputting the combined fault data into a multi-attention transformer neural network;
performing a monitoring task comprising using the non-faulty sensor data; and
pre-training the CNN comprising providing the indicators to both a faulty sensor data classifier neural network and a domain adaptive neural network (DA-NN) arranged to increase generalization of the CNN to cross-domains with the same group of sensors but with different environments from domain to domain affecting the same group of sensors.

17. The medium of claim 16, wherein the instructions cause the computing device to operate by generating a normalization Â of an adjacency matrix Ã by: Â=\tilde{D}^{-1/2} Ã \tilde{D}^{-1/2}, where D is a diagonal degree matrix of connecting weight sums of individual dependency values, and Ã is a matrix of the spatial or temporal dependency values, wherein the connecting weight sums are each a sum of the spatial or temporal dependency values having an edge connected to an individual sensor value.

18. The medium of claim 17, wherein the instructions cause the computing device to operate by multiplying the normalized adjacency matrix by feature channel data from a prior CNN block.

19. The medium of claim 16, wherein the instructions cause the computing device to operate by converting a version of the indicators and a version of the sensor data into separate embeddings expected for positional encoding; and performing multi-variant word embedding to combine the separate embeddings into a combined vector to be input to the multi-attention transformer neural network.

20. The medium of claim 19, wherein the multi-attention transformer neural network comprises a spatial encoder that receives the combined vector and a temporal encoder that receives a concatenation of output from the spatial encoder and the combined vector.
